(19) United States
(12) Patent Application Publication
(10) Pub. No.: US 2026/0100308 A1
(43) Pub. Date: Apr. 9, 2026

(54) DUAL-COILED TRANSFORMER INDUCTOR

(71) Applicant: Intel Corporation, Santa Clara, CA (US)

(72) Inventors: Jagadish V. Singh, Bangalore (IN); Manikandan M, Bangalore (IN); Gayatri Nayak, Bangaluru, Karnataka (IN)

(21) Appl. No.: 19/393,088

(22) Filed: Nov. 18, 2025

(51) Int. Cl. H01F 27/32; H01F 27/24; H02M 1/00; H02M 3/00

(52) U.S. Cl. CPC H01F 27/32; H01F 27/24; H02M 1/0064; H02M 3/003

(57) ABSTRACT

The present disclosure provides a transformer inductor, including: a primary power coil; a secondary coil positioned concentrically with respect to the primary power coil; a dielectric positioned between the primary power coil and the secondary coil to provide electrical isolation while enabling magnetic coupling therebetween; a molded magnetic material at least partially encasing the primary power coil and the secondary coil; and a hard saturation magnetic material disposed at the secondary coil and configured to provide a higher inductance at lower current levels and a reduced inductance at higher current levels, wherein the primary power coil and the secondary coil are configured to provide magnetic coupling enabling both inductive energy storage and transformer coupling.

### TECHNICAL FIELD

The present disclosure relates to power delivery systems for electronic devices, and more particularly to a dual-coiled transformer inductor structure for ultra-low-profile voltage regulation in mobile devices using tightly coupled primary and secondary coils separated by a dielectric layer or ferromagnetic material.

### BACKGROUND

Modern electronic devices, particularly mobile platforms such as laptops, tablets, and smartphones, demand increasingly sophisticated power delivery systems to support high-performance system-on-chip (SoC) architectures. These devices operate under stringent form factor constraints, requiring ultra-thin profiles while maintaining efficient power conversion and regulation capabilities.

Traditional voltage regulation approaches utilize discrete inductors in multi-phase buck converter topologies to deliver power to processor cores and other high-current loads. Conventional inductors are typically in the 100-470 nH range and are implemented as single-coil structures with ferrite or powder iron cores. While these solutions provide adequate performance for many applications, they face limitations in achieving improved transient response characteristics and space efficiency.

Transformer inductor voltage regulator (TLVR) topologies have emerged as an alternative approach, offering enhanced transient performance through magnetic coupling between inductor phases. TLVR implementations can reduce output capacitance requirements and improve dynamic response to load changes. However, existing TLVR inductors predominantly utilize clip-based or side-by-side winding configurations that result in relatively large form factors unsuitable for ultra-thin mobile devices.

Current TLVR inductors designed for server and desktop applications typically exhibit heights ranging from 4-12 mm, making them incompatible with mobile device z-height constraints of 3 mm or less. Additionally, achieving high inductance values above 150 nH while maintaining tight magnetic coupling presents manufacturing challenges with conventional clip transformer inductor structures. The TLVR topology requires additional compensating inductors beyond the conventional multiphase buck converters, thus it requires more space.

The power delivery requirements for mobile devices continue to evolve, driving a desire for compact, efficient voltage regulation solutions that can deliver both high steady-state efficiency and rapid transient response within the physical constraints of modern portable electronics. Conventional TLVR topology impacts light load efficiency due to circulating current, hence for the client segment, there is a need to use a swing inductor as the compensating inductor that gives high inductance and light load and low inductance at heavy load.

### BRIEF DESCRIPTION OF THE FIGURES

Non-limiting and non-exhaustive examples are described with reference to the following figures.

FIG. 1A illustrates a perspective view of a transformer inductor with concentric coils, according to aspects of the present disclosure.

FIG. 1B illustrates a top view of the transformer inductor of FIG. 1A, according to aspects of the present disclosure.

FIG. 1C illustrates a side view of the transformer inductor of FIG. 1A, according to aspects of the present disclosure.

FIG. 1D illustrates a perspective exploded view of the transformer inductor showing a detailed concentric coil structure, according to aspects of the present disclosure.

FIG. 1E illustrates a perspective view of the transformer inductor within molded magnetic material, according to aspects of the present disclosure.

FIG. 2A depicts a graph showing inductance versus current characteristics for a primary power coil, according to aspects of the present disclosure.

FIG. 2B depicts a graph showing inductance versus current characteristics for a secondary coupling coil, according to aspects of the present disclosure.

FIG. 2C depicts a graph showing coupling coefficient versus current characteristics, according to aspects of the present disclosure.

FIG. 3A illustrates an isometric view of a transformer inductor with broadside coupling, according to aspects of the present disclosure.

FIG. 3B illustrates a perspective view of the transformer inductor of FIG. 3A within molded magnetic material, according to aspects of the present disclosure.

FIG. 4 illustrates a circuit diagram of an HMSI transformer inductor circuit, according to aspects of the present disclosure.

FIG. 5A illustrates a perspective view of an HMSI transformer inductor structure, according to aspects of the present disclosure.

FIG. 5B illustrates another perspective view of the HMSI transformer inductor structure of FIG. 5A, according to aspects of the present disclosure.

FIG. 6 illustrates a multiple-phase buck converter circuit incorporating HMSI transformer inductors, according to aspects of the present disclosure.

FIG. 7A depicts a table showing phase configuration and compensation inductance relationships, according to aspects of the present disclosure.

FIG. 7B depicts a table showing operating conditions and performance impacts, according to aspects of the present disclosure.

FIG. 8 illustrates a flowchart of a manufacturing process for an HMSI transformer inductor, according to aspects of the present disclosure.

FIG. 9 depicts a graph showing inductance versus DC bias current for a secondary coil, according to aspects of the present disclosure.

FIG. 10A depicts a graph comparing current waveforms for traditional and HMSI TLVR configurations, according to aspects of the present disclosure.

FIG. 10B depicts a graph comparing transient response characteristics for different TLVR configurations, according to aspects of the present disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

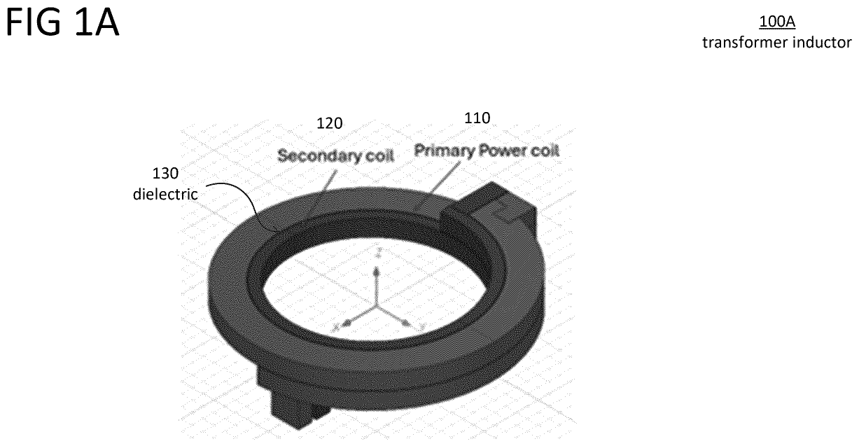

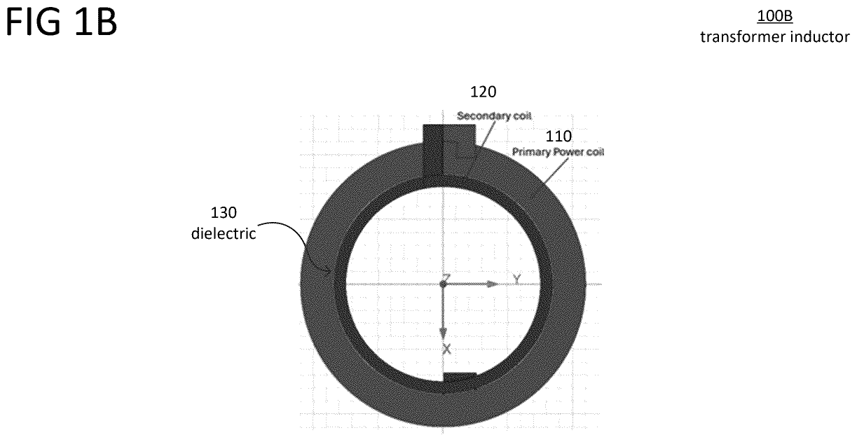

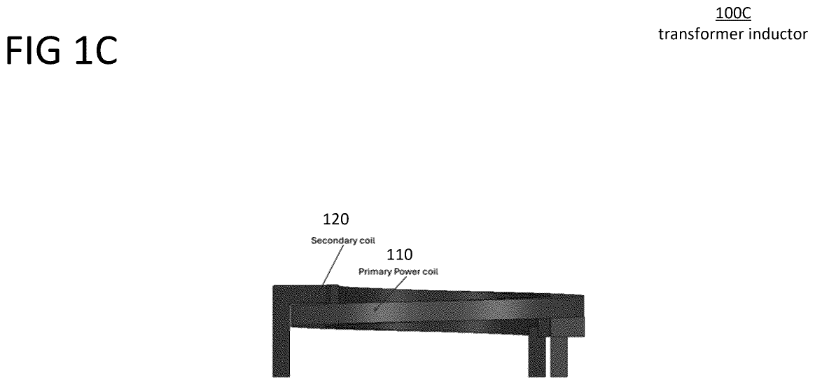

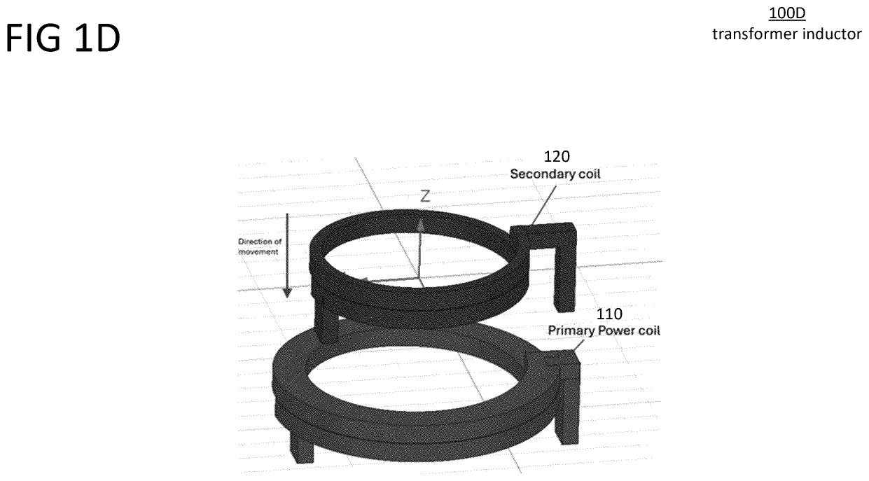

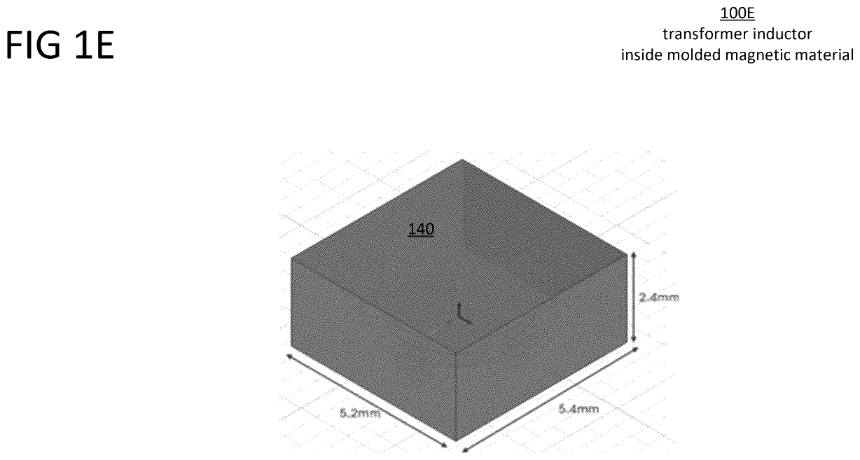

Referring to FIG. 1A, a transformer inductor 100A may comprise a concentric coil configuration designed for transformer inductor voltage regulator (TLVR) applications in mobile devices. The transformer inductor 100A may include a primary power coil 110 and a secondary coil 120 arranged around an axis in a concentric structure that enables tight magnetic coupling (with a coupling coefficient k≥0.9) while maintaining electrical isolation between the coils. Each aspect of the transformer inductor 100 (100A-100E) may represent different structural views or implementations of the same concentric inductor concept.

The primary power coil 110 may form an outer coil structure that carries the main power current in the transformer inductor 100A. In some cases, the primary power coil 110 may be configured as a flat, ribbon-like conductor that follows a continuous loop path to reduce DC resistance and improve thermal performance. The primary power coil 110 may be constructed from copper to provide good electrical conductivity and cost-effectiveness. In some cases, the primary power coil 110 may alternatively be made of gold, silver, aluminum, or alloys of different materials, depending on the specific application requirements and cost considerations.

The secondary coil 120 may form an inner coil structure positioned concentrically within the primary power coil 110. The secondary coil 120 may be configured to provide magnetic coupling functionality rather than carrying high power currents. In some cases, the secondary coil 120 may have a thinner cross-sectional profile compared to the primary power coil 110, as the secondary coil 120 may not need to handle the same current levels as the primary power coil 110. The secondary coil 120 may also be constructed from copper, or alternatively from gold, silver, aluminum, or alloys of different materials. The primary power coil 110 and the secondary coil 120 may each have a circular, rectangular, or square shape, for example.

A dielectric 130 may be disposed between the primary power coil 110 and the secondary coil 120 to provide electrical isolation while maintaining close physical proximity for magnetic coupling. The dielectric 130 may comprise a micro-thin, high breakdown insulating layer that enables the transformer inductor 100A to achieve a coupling coefficient approaching unity. In some cases, the dielectric 130 may be formed from urethane material. The dielectric 130 may, alternatively, comprise polyimide material or epoxy glass material to provide the electrical isolation between the primary power coil 110 and the secondary coil 120. A chemical process, such as oxidation, could also provide electrical isolation between the primary and secondary coils, as described earlier.

The concentric arrangement of the primary power coil 110 and secondary coil 120 may increase in-plane mutual overlap between the conductors, enabling efficient magnetic coupling between the coils. This concentric configuration may enable the transformer inductor 100A to achieve high coupling coefficients while maintaining a low-profile form factor suitable for integration into compact electronic devices. The transformer inductor 100A may be configured to operate with packaging heights below 3 mm, making the structure suitable for ultra-thin laptops, tablets, and other mobile devices where space constraints are stringent.

Referring to FIG. 1B, the transformer inductor 100B may be viewed from above to show the concentric arrangement of the primary power coil 110 and the secondary coil 120. The transformer inductor 100B may, alternatively, exhibit a substantially square or rectangular configuration when viewed from the top, demonstrating how the concentric coil structure may be implemented in various geometric forms to accommodate different packaging requirements and design constraints.

The primary power coil 110 may form the outer perimeter of the transformer inductor 100B, defining the overall footprint of the concentric structure. In some cases, the primary power coil 110 may follow a rectangular cross-section that provides a larger conductor cross-sectional area compared to circular configurations, potentially reducing DC resistance and improving current-carrying capacity. In some other cases, the primary power coil 110 may follow a rectangular path with either a circular or rectangular cross-section that can increase the coil length and thus increase the effective inductance of the coil. The rectangular configuration of the primary power coil 110 may also facilitate more efficient use of available PCB real estate in mobile device applications.

The secondary coil 120 may be positioned concentrically within the primary power coil 110, following a similar rectangular or square path that maintains consistent spacing from the primary power coil 110 around the entire perimeter. The concentric arrangement may increase the mutual overlap area between the primary power coil 110 and the secondary coil 120, enabling the transformer inductor 100B to achieve coupling coefficients suitable for TLVR applications.

The dielectric 130 may maintain electrical separation between the primary power coil 110 and the secondary coil 120 throughout the concentric structure. In some cases, the dielectric 130 may be formed through oxidation processes applied to both sides of the coils rather than being implemented as a separate film layer. The oxidation process may create a thin insulating layer directly on the conductor surfaces, providing electrical isolation while maintaining the close physical proximity needed for high magnetic coupling.

In some cases, the dielectric 130 may be formed through chemical vapor deposition methods rather than being implemented as a separate film. Chemical vapor deposition may enable precise control of the dielectric thickness and properties, allowing the transformer inductor 100B to achieve the desired electrical isolation characteristics while maintaining the compact form factor.

The transformer inductor 100B may alternatively be configured with a circular coil structure instead of the square or rectangular configuration shown. A circular coil structure may provide different magnetic field distribution characteristics and may be suitable for applications where circular symmetry is preferred. In some cases, the transformer inductor 100B may be implemented with various rectangular coil structures having different aspect ratios to optimize the magnetic coupling and form factor for specific mobile device applications.

Referring to FIG. 1C, a transformer inductor 100C may be viewed from the side to illustrate the horizontal cross-sectional profile of the concentric coil arrangement. The side view may demonstrate how the primary power coil 110 and the secondary coil 120 may be positioned to achieve a flat, low-profile structure that enables integration into compact form factors with reduced z-height requirements.

The transformer inductor 100C may exhibit a horizontal profile where the secondary coil 120 may be nested within the primary power coil 110 in the same horizontal plane. This side view may show how the concentric arrangement may maintain the close physical proximity between the primary power coil 110 and the secondary coil 120 while preserving electrical isolation through the dielectric layer separating the coils.

The flat, low-profile structure of the transformer inductor 100C may enable packaging heights below 3 mm, making the structure suitable for mobile device applications where z-height constraints are stringent. In some cases, the transformer inductor 100C may achieve packaging heights as low as 2.4 mm, 2 mm, or even lower, while maintaining the magnetic coupling characteristics needed for TLVR functionality. The reduced z-height may be particularly advantageous for ultra-thin laptops, tablets, and other compact form-factor devices where vertical space is limited.

The horizontal cross-sectional profile may increase the mutual overlap between the primary power coil 110 and the secondary coil 120 by positioning the coils in substantially the same plane. This arrangement may facilitate a high coupling coefficient approaching unity while maintaining the compact form factor. The mutual overlap area between the primary power coil 110 and the secondary coil 120 may be increased through the concentric positioning, enabling efficient magnetic coupling between the coils.

In some cases, the positions of the primary power coil 110 and the secondary coil 120 may be interchanged in the transformer inductor 100C. The inner coil may serve as the power coil while the outer coil may serve as the coupling coil, depending on the specific design requirements and application constraints. This flexibility in coil positioning may allow designers to optimize the transformer inductor 100C for different current handling requirements and magnetic coupling characteristics while maintaining the low-profile form factor suitable for mobile device integration.

Referring to FIG. 1D, a transformer inductor 100D may provide a detailed perspective view of the concentric coil structure showing the flat, ribbon-like conductors in greater detail. The transformer inductor 100D may comprise the primary power coil 110 and the secondary coil 120 arranged to follow parallel paths in substantially the same plane, demonstrating how the flat conductor geometry may be implemented to achieve improved electrical and thermal performance characteristics.

The primary power coil 110 may be configured as a flat, ribbon-like conductor that forms an outer ring structure with a rectangular or square cross-section. The flat conductor geometry of the primary power coil 110 may provide a larger cross-sectional area compared to wire-based implementations, which may reduce DC resistance and improve current-carrying capacity. In some cases, the reduced DC resistance of the primary power coil 110 may lead to lower power losses and improved thermal performance during operation. The flat conductor configuration may also facilitate better heat dissipation compared to round wire conductors by providing increased surface area for thermal conduction.

The secondary coil 120 may be positioned concentrically within the primary power coil 110 and may also be configured as a flat, ribbon-like conductor following a similar geometric profile. The secondary coil 120 may follow a parallel path to the primary power coil 110 in the same plane, maintaining consistent spacing throughout the concentric structure. The flat conductor geometry of the secondary coil 120 may similarly provide reduced DC resistance compared to wire-based implementations, contributing to improved conversion efficiency of the transformer inductor 100D.

The parallel paths followed by the primary power coil 110 and the secondary coil 120 may increase the mutual coupling area between the conductors while maintaining the flat, low-profile configuration. In some cases, the parallel path arrangement may enable the transformer inductor 100D to achieve coupling coefficients approaching unity while preserving the compact form factor suitable for mobile device applications.

The flat conductor geometry of both the primary power coil 110 and the secondary coil 120 may provide improved thermal performance compared to wire-based implementations. The increased surface area of the flat conductors may facilitate better heat transfer to the surrounding magnetic core material, enabling the transformer inductor 100D to operate at higher current levels without excessive temperature rise. The improved thermal characteristics may be particularly advantageous in mobile device applications where the compact form factor constrains thermal management.

In some cases, the transformer inductor 100D may be manufactured by forming the primary power coil 110 and the secondary coil 120 separately and then assembling the coils concentrically before molding. The separate formation process may enable precise control over the conductor dimensions and spacing between the coils. The primary power coil 110 and the secondary coil 120 may be formed using stamping, etching, or other precision manufacturing techniques to achieve the desired flat conductor geometry and dimensional tolerances.

The concentric assembly process may involve positioning the secondary coil 120 within the primary power coil 110 while maintaining the dielectric separation between the conductors. In some cases, the dielectric separation may be maintained through precise mechanical positioning during assembly, or through the application of insulating coatings to one or both of the coil surfaces. Following the concentric assembly, the coil structure may be encapsulated with magnetic core material through molding processes to complete the transformer inductor 100D.

Referring to FIG. 1E, a transformer inductor 100E may be encased within a molded magnetic material 140 to provide magnetic shielding, flux containment, and structural support while maintaining the low-profile configuration suitable for compact electronic applications. The molded magnetic material 140 may form a rectangular enclosure that surrounds the concentric coil structure of the transformer inductor 100E, creating a complete inductor package with integrated magnetic core functionality.

The molded magnetic material 140 may encapsulate the primary power coil 110, the secondary coil 120, and the dielectric 130 within a unified magnetic structure. The encapsulation process may integrate the coil assembly with the molded magnetic material 140 through co-molding techniques, where the magnetic material may be formed around the concentric coil structure to create a monolithic inductor component. The molded magnetic material 140 may provide structural support for the delicate coil assembly while protecting the conductors from mechanical damage during handling and assembly.

The molded magnetic material 140 may provide magnetic flux containment for the transformer inductor 100E by creating a controlled magnetic flux path around the concentric coils. The magnetic flux generated by current flow through the primary power coil 110 and the secondary coil 120 may be contained within the molded magnetic material 140, reducing electromagnetic interference (EMI) and preventing magnetic flux leakage that could affect nearby electronic components. The flux containment properties of the molded magnetic material 140 may enable the transformer inductor 100E to operate effectively in densely packed mobile device layouts where multiple magnetic components may be positioned in close proximity.

In some cases, the molded magnetic material 140 may comprise ferrite material that provides low-loss magnetic properties over a wide frequency range. Ferrite-based molded magnetic material 140 may offer good magnetic permeability characteristics while maintaining low core losses at the switching frequencies typically used in mobile device power delivery applications. The ferrite composition of the molded magnetic material 140 may be selected to optimize the magnetic properties for the specific operating frequency and current levels of the transformer inductor 100E.

The molded magnetic material 140 may alternatively comprise iron powder instead of ferrite material. Iron powder-based molded magnetic material 140 may provide different magnetic saturation characteristics compared to ferrite materials and may be suitable for applications requiring higher current handling capability. The iron powder composition may offer cost advantages while providing adequate magnetic performance for many mobile device applications.

In some cases, the molded magnetic material 140 may comprise Manganese-zinc alloy to provide specific magnetic permeability and loss characteristics. Manganese-zinc alloy compositions may offer optimized magnetic properties for certain frequency ranges and may provide improved temperature stability compared to other magnetic materials. The Manganese-zinc alloy composition of the molded magnetic material 140 may be selected based on the specific operating requirements of the transformer inductor 100E.

The molded magnetic material 140 may alternatively comprise ferrite, iron powder, Manganese-Zinc, Nickel-Zinc, Nickel-Zinc alloy, Iron-Nickel, nano-crystalline alloy, or a suitable ferromagnetic material to achieve different magnetic performance characteristics. Such materials may provide alloy compositions that may provide enhanced magnetic properties such as higher saturation flux density or improved temperature coefficient characteristics. The selection of alloy for the molded magnetic material 140 may depend on the specific performance requirements and operating conditions of the mobile device application.

The three-dimensional arrangement shown in FIG. 1E may demonstrate how the transformer inductor 100E may be embedded within the molded magnetic material 140 to create a complete surface-mount device (SMD) component. The rectangular form factor of the molded magnetic material 140 may be compatible with standard SMD assembly processes used in mobile device manufacturing. The molded magnetic material 140 may define the overall external dimensions of the transformer inductor 100E while maintaining the low-profile configuration needed for integration into compact electronic devices with stringent z-height requirements.

The molded magnetic material 140 may enable the transformer inductor 100E to achieve the desired inductance values while maintaining the compact form factor. The magnetic properties of the molded magnetic material 140 may be selected to provide the magnetic flux path needed to achieve inductance values≥150 nH at operating frequencies around 600 kHz or less. The combination of the concentric coil structure or the broad side coupled structure and the molded magnetic material 140 may enable the transformer inductor 100E to meet both the electrical performance requirements and the physical constraints of mobile device applications.

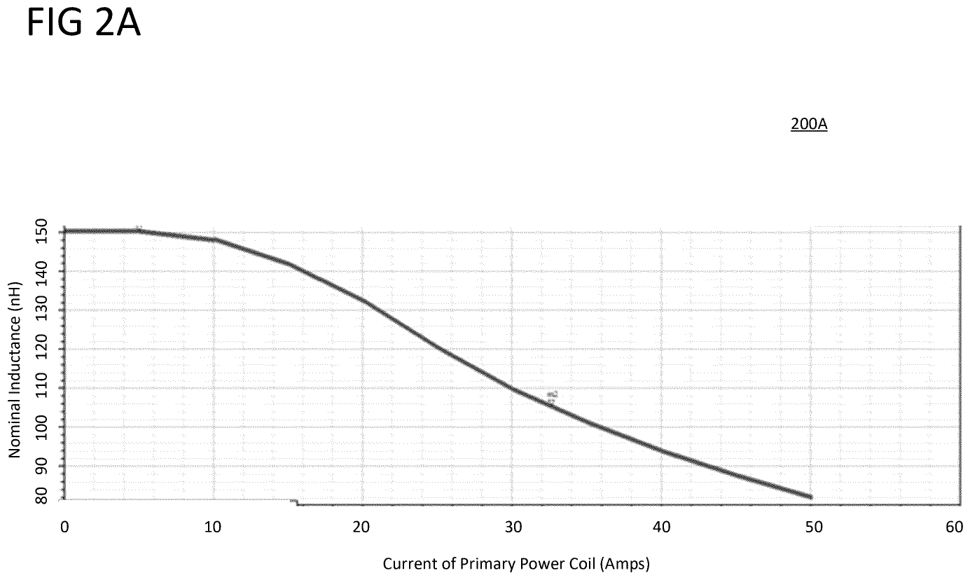

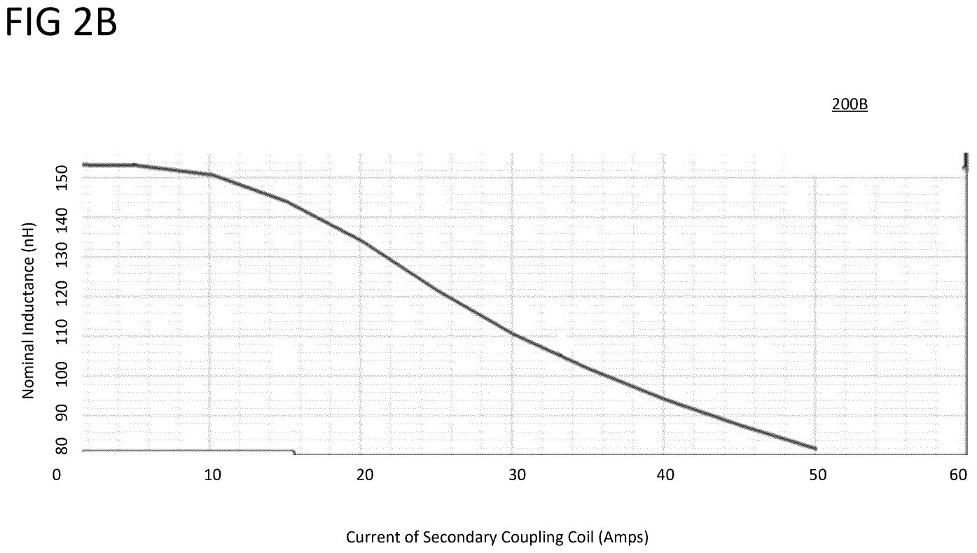

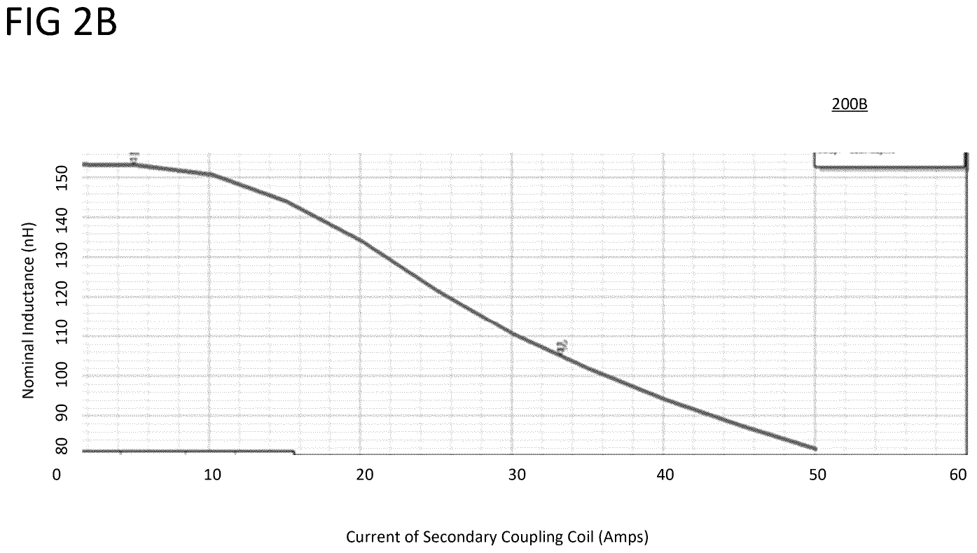

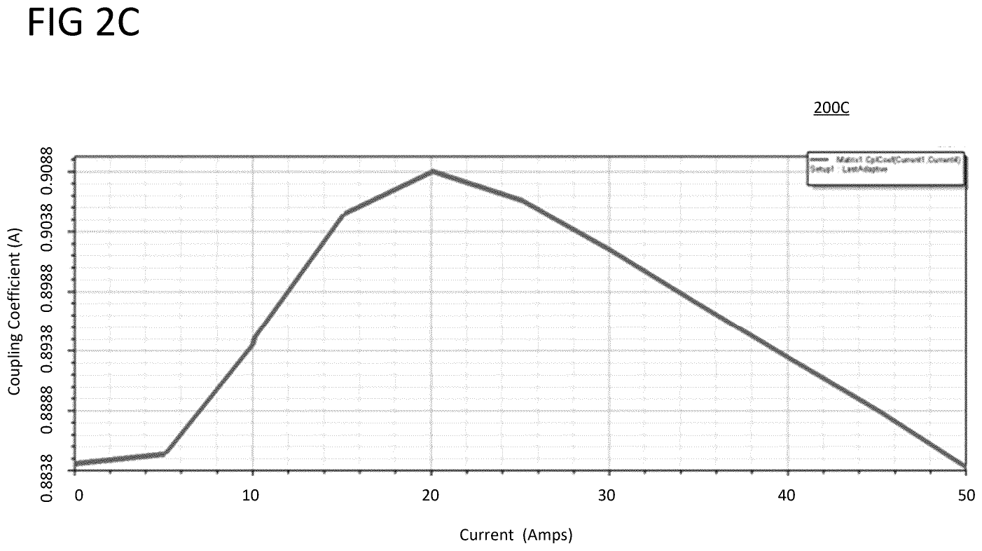

Referring to FIG. 2A, a graph 200A illustrates the relationship between nominal inductance and current for the primary power coil 110 of the transformer inductor 100. The graph 200A demonstrates how the inductance characteristics of the primary power coil 110 may vary across different current levels, providing insight into the saturation behavior and operating range of the transformer inductor.

The graph 200A shows that the nominal inductance of the primary power coil 110 remains relatively stable at approximately 150 nH across low current levels from 0 to about 5 amperes. This stable inductance region represents the linear operating range of the primary power coil 110 where the magnetic core material does not experience significant saturation effects. The 150 nH inductance value is selected to enable the transformer inductor to operate at 600 kHz switching frequency, providing a balance of efficiency and size for mobile device applications.

As shown in the graph 200A, the inductance of the primary power coil 110 begins to decrease gradually as the current increases beyond approximately 5 amperes. The inductance may decline to approximately 145 nH at around 10 amperes, demonstrating the onset of magnetic saturation in the core material. The gradual decrease in inductance through the mid-range currents indicates that the magnetic core material exhibits soft saturation characteristics, allowing for continued operation at elevated current levels with reduced but still functional inductance values.

The graph 200A further shows that the inductance of the primary power coil 110 continues to decline more steeply as the current increases through higher current ranges. The inductance drops to approximately 80 nH at 50 amperes, representing a significant reduction from the nominal 150 nH value. This steep decline in inductance at higher currents indicates that the magnetic core material approaches deeper saturation, where further increases in current produces diminishing increases in magnetic flux.

The inductance characteristics shown in graph 200A may be affected by manufacturing tolerances that may result in plus or minus 20% variation from the nominal 150 nH value. The manufacturing tolerance may cause the actual inductance of the primary power coil 110 to range from approximately 120 nH to 180 nH under nominal operating conditions. The lower tolerance limit of 120 nH may define the minimum inductance value that may be expected during continuous current operation within the specified tolerance window.

In some cases, the primary power coil 110 may maintain inductance values within the tolerance window up to approximately 25 amperes of continuous current, as demonstrated by the graph 200A. The operating range up to 25 amperes may provide adequate current handling capability for many mobile device power delivery applications while maintaining inductance values above the lower tolerance limit of 120 nH.

The saturation current of the primary power coil 110 may be defined as the current level at which the inductance drops by 30% from the nominal value. Based on the characteristics shown in the graph 200A, a 30% reduction from the nominal 150 nH value may correspond to an inductance of approximately 105 nH. The saturation current may occur at current levels between approximately 32 to 45 amperes, where the inductance may reach the 30% reduction threshold.

The soft saturation characteristics demonstrated in graph 200A may enable the primary power coil 110 to operate beyond the 30% inductance reduction point when higher current handling capability may be needed. The soft saturation behavior may allow the transformer inductor 100 to continue functioning at current levels exceeding the defined saturation current, albeit with further reduced inductance values that may affect the electrical performance of the power delivery system, but may be beneficial from the transient-response point of view when dealing with lower inductance

Referring to FIG. 2B, a graph 200B illustrates the relationship between nominal inductance and current for the secondary coil 120 of the transformer inductor. The graph 200B demonstrates the inductance characteristics of the secondary coil 120 across different current levels, showing how the secondary coil 120 maintains stable inductance values throughout its operating range while exhibiting different saturation behavior compared to the primary power coil 110.

The graph 200B shows that the nominal inductance of the secondary coil 120 begins at approximately 150 nH at low current levels, similar to the primary power coil 110. This matching inductance value facilitates balanced magnetic coupling between the primary power coil 110 and the secondary coil 120 in the concentric transformer configuration. The 150 nH starting value of the secondary coil 120 enables the transformer inductor to achieve the desired coupling characteristics for TLVR applications while maintaining compatibility with the magnetic properties of the primary power coil 110.

As demonstrated in the graph 200B, the secondary coil 120 maintains a relatively gradual decline in inductance across the current range up to approximately 50 A, indicating soft magnetic saturation behavior similar to the primary coil but with slightly delayed onset. The stable inductance characteristics of the secondary coil 120 throughout this current range indicate that the secondary coil 120 may experience less magnetic saturation effects compared to the primary power coil 110. The extended stable operating range of the secondary coil 120 may be attributed to the different current distribution and magnetic field patterns that may occur in the concentric coil arrangement. A similar behavior is to be expected out of the broad side coupled TLVR inductor structure.

The graph 200B shows that the inductance of the secondary coil 120 remains relatively constant through the majority of the operating current range before beginning to decrease as the current approaches higher levels. The delayed onset of inductance reduction in the secondary coil 120 compared to the primary power coil 110 may result from the different magnetic flux paths and saturation characteristics that may occur in the concentric transformer structure. The secondary coil 120 may experience different magnetic field intensities due to its position within the primary power coil 110, which may affect the saturation behavior of the magnetic core material surrounding the secondary coil 120.

The secondary coil 120 may be configured with a thinner coil structure compared to the primary power coil 110, as the secondary coil 120 may not need to carry the same high current levels as the primary power coil 110. The thinner coil structure of the secondary coil 120 may result in higher effective series resistance compared to the primary power coil 110. The increased effective series resistance of the secondary coil 120 may represent a design trade-off that enables the compact concentric design while maintaining the magnetic coupling functionality needed for TLVR operation.

In some cases, the higher effective series resistance of the secondary coil 120 may be acceptable because the secondary coil 120 primarily serves a coupling function rather than carrying high power currents. The secondary coil 120 facilitates magnetic coupling between phases in a multi-phase converter configuration without needing to handle the same current levels as the primary power coil 110. The trade-off between conductor size and effective series resistance in the secondary coil 120 may enable the overall transformer inductor to achieve the desired compact form factor while maintaining adequate electrical performance.

The thinner coil structure of the secondary coil 120 enables the concentric design to fit within the stringent z-height constraints of mobile device applications. By reducing the cross-sectional area of the secondary coil 120, the overall thickness of the concentric coil assembly may be reduced, allowing the transformer inductor to achieve packaging heights below 3 mm. The size optimization of the secondary coil 120 may be particularly advantageous for ultra-thin laptops, tablets, and other compact form-factor devices where vertical space may be limited.

The inductance characteristics shown in graph 200B demonstrate that the secondary coil 120 may provide stable magnetic coupling performance across the operating current range of typical mobile device applications. The stable inductance values of the secondary coil 120 may enable consistent coupling coefficients between the primary power coil 110 and the secondary coil 120, facilitating predictable TLVR performance characteristics. The extended stable operating range of the secondary coil 120 may provide design margin for applications that may require operation at varying current levels or transient conditions.

Referring to FIG. 2C, graph 200C illustrates the relationship between coupling coefficient and current for the transformer inductor, demonstrating the magnetic coupling performance characteristics across the operating current range. The graph 200C shows coupling coefficient values plotted against current measured in amperes, providing insight into how the concentric coil arrangement maintains consistent magnetic coupling between the primary power coil 110 and the secondary coil 120 throughout different operating conditions.

The graph 200C demonstrates that the coupling coefficient varies within a narrow range, increasing from approximately 0.88 at low current to about 0.91 around 20 amperes and then gradually decreasing toward 0.88 as current approaches 50 amperes. This limited variation indicates that the concentric arrangement of the primary power coil 110 and secondary coil 120 maintains strong magnetic coupling across the operating current range while reducing coupling degradation under high-current conditions. The consistent high-coupling behavior enables predictable TLVR operation under varying load conditions encountered in mobile device applications.

The coupling coefficient values approaching 0.90 may represent tight magnetic coupling between the primary power coil 110 and the secondary coil 120 in the concentric transformer configuration. The high coupling coefficient may result from the increased mutual overlap area between the concentrically arranged coils, where the magnetic flux generated by one coil may effectively link with the other coil. The concentric positioning may enable the transformer inductor 100 to achieve coupling coefficients approaching unity, which may be advantageous for TLVR applications that rely on strong magnetic coupling between phases.

In some cases, the tight coupling coefficient demonstrated in graph 200C may enable the transformer inductor 100 to achieve TLVR performance characteristics that may provide improved transient response compared to conventional uncoupled inductors. The high coupling coefficient may facilitate rapid current sharing between phases during load transients, enabling faster voltage regulation response and reduced output voltage overshoot. The consistent coupling performance across the current range may ensure that the TLVR benefits may be maintained throughout different operating conditions.

The stable coupling coefficient characteristics shown in graph 200C may result from the precise geometric arrangement of the primary power coil 110 and the secondary coil 120 in the concentric configuration. The consistent spacing between the coils maintained by the dielectric 130 may contribute to the uniform magnetic coupling throughout the current range. The concentric geometry may reduce variations in the magnetic flux linkage between the coils that might otherwise occur with different coil arrangements or varying current levels. A similar stable coupling coefficient may be achievable even in the case of the broad side coupled structure for the TLVR.

The coupling coefficient approaching unity may enable the transformer inductor 100 to function effectively in multi-phase converter configurations where magnetic coupling between phases may be used to improve overall system performance. The high coupling coefficient, along with appropriately designed voltage regulator controller behavior, may facilitate current balancing between phases and may also reduce the output capacitance requirements compared to systems using uncoupled inductors. The reduced output capacitance requirements for the rail may enable smaller bill of materials and improved power density in mobile device applications where space constraints may be stringent.

In some cases, the coupling coefficient may be further optimized by using compensation inductors in the TLVR circuit configuration. The compensation inductors can be used to adjust the effective coupling between phases, thereby achieving the desired balance between steady-state efficiency and transient response performance. The stable coupling coefficient characteristics demonstrated in graph 200C may provide a consistent foundation for implementing compensation techniques that may fine-tune the TLVR performance for specific application requirements.

The tight coupling coefficient performance may enable the transformer inductor 100 to achieve server-class voltage regulation characteristics in mobile device form factors. The high coupling coefficient may provide the magnetic coupling strength needed to implement TLVR topologies that may offer superior transient performance compared to conventional voltage regulation approaches. The combination of tight coupling and compact form factor may enable mobile devices to achieve improved power delivery performance while meeting the stringent size and height constraints typical of ultra-thin laptops and tablets.

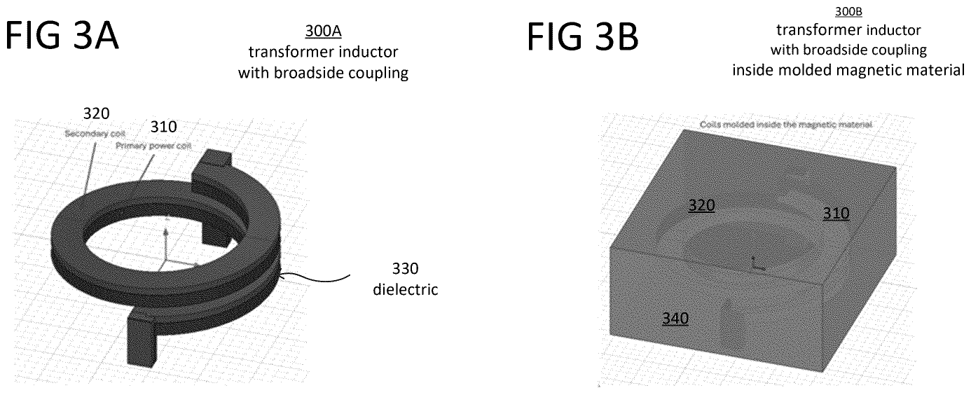

Referring to FIG. 3A and FIG. 3B, a transformer inductor 300A may be configured with a broadside coupling arrangement that provides an alternative implementation to the concentric coil structure previously described. The transformer inductor 300A may achieve magnetic coupling between coils through coupling in the Z plane, where the coils may be positioned in different horizontal layers rather than concentrically within the same plane.

The transformer inductor 300A may comprise a primary power coil 310 and a secondary coil 320 arranged in a broadside-coupled configuration. In the broadside coupling arrangement, the primary power coil 310 and the secondary coil 320 may be positioned in substantially parallel planes that may be separated vertically in the Z direction. This vertical separation may enable magnetic coupling between the primary power coil 310 and the secondary coil 320 through the overlapping areas of the coils in different Z planes.

The primary power coil 310 may be configured as a flat, planar conductor that may be positioned in one horizontal layer of the transformer inductor 300A. The primary power coil 310 may follow a rectangular, square, or circular path within its horizontal plane to define the current flow path for the main power current. In some cases, the primary power coil 310 may be formed using flat ribbon conductors or patterned metal traces to achieve the desired current-carrying capacity while maintaining the low-profile form factor suitable for mobile device applications.

The secondary coil 320 may be positioned in a different horizontal layer from the primary power coil 310, creating the broadside coupling configuration. The secondary coil 320 may follow a similar geometric path to the primary power coil 310 within its horizontal plane, providing overlapping areas that may facilitate magnetic coupling between the coils. The secondary coil 320 may be configured to provide the coupling functionality needed for TLVR operation while maintaining electrical isolation from the primary power coil 310.

A dielectric 330 may be disposed between the primary power coil 310 and the secondary coil 320 to provide electrical isolation while enabling magnetic coupling through the Z plane. The dielectric 330 may comprise a thin insulating layer that may separate the horizontal planes containing the primary power coil 310 and the secondary coil 320. In some cases, the dielectric 330 may be formed from polyimide material, urethane material, or epoxy glass material to provide the electrical isolation characteristics needed for safe operation of the transformer inductor 300A.

The dielectric 330 may be configured with a thickness that may balance the competing requirements of electrical isolation and magnetic coupling strength. A thinner dielectric 330 may provide stronger magnetic coupling between the primary power coil 310 and the secondary coil 320 but may require higher breakdown voltage characteristics to maintain electrical isolation. A thicker dielectric 330 may provide enhanced electrical isolation but may reduce the magnetic coupling strength between the coils. The thickness of the dielectric 330 may be selected based on the specific voltage and coupling requirements of the TLVR application. Such an isolation could be through a layer of oxidation or any other chemical process that would help develop a layer of electrical isolation while being thin enough to allow for magnetic coupling.

The broadside coupling configuration may enable the transformer inductor 300A to achieve coupling coefficients suitable for TLVR applications while providing an alternative manufacturing approach compared to concentric coil structures. The broadside arrangement may facilitate the use of standard printed circuit board manufacturing techniques or flexible circuit fabrication methods to create the primary power coil 310 and the secondary coil 320. The planar nature of the broadside coupling configuration may be compatible with lamination processes that may be used to assemble multi-layer magnetic structures.

As shown in FIG. 3B, a molded magnetic material 340 may encapsulate the transformer inductor 300A to provide magnetic shielding, structural support, and electromagnetic interference (EMI) containment. The molded magnetic material 340 may surround the broadside coupled structure comprising the primary power coil 310, the secondary coil 320, and the dielectric 330, creating a complete inductor package with integrated magnetic core functionality.

The molded magnetic material 340 may provide magnetic flux containment for the transformer inductor 300A by creating controlled magnetic flux paths around the broadside coupled coils. The magnetic flux generated by current flow through the primary power coil 310 and the secondary coil 320 may be contained within the molded magnetic material 340, reducing electromagnetic interference and preventing magnetic field leakage that could affect nearby electronic components in mobile device applications.

The molded magnetic material 340 may comprise ferrite material, iron powder, or other magnetic materials that may provide low-loss magnetic properties suitable for the operating frequency range of mobile device power delivery systems. The selection of the molded magnetic material 340 may be based on factors such as magnetic permeability, core loss characteristics, saturation flux density, and temperature stability requirements of the specific application.

The molded magnetic material 340 may enable the transformer inductor 300A to maintain low EMI characteristics while operating in the compact, densely packed electronic environments typical of mobile devices. The magnetic shielding provided by the molded magnetic material 340 may prevent the transformer inductor 300A from interfering with nearby sensitive circuits, such as radio frequency components, sensors, or other magnetic elements that may be present in mobile device designs.

The molded magnetic material 340 may preserve the ultra-low-profile form factor of the transformer inductor 300A by providing a compact encapsulation that may maintain packaging heights below 3 mm. The broadside coupling configuration encapsulated within the molded magnetic material 340 may achieve the desired inductance values and coupling characteristics while meeting the stringent z-height constraints of ultra-thin laptops, tablets, and other compact mobile devices.

In some cases, the molded magnetic material 340 may be applied through co-molding processes where the magnetic material may be formed around the broadside coupled coil assembly to create a monolithic structure. The co-molding process may provide intimate contact between the molded magnetic material 340 and the coil surfaces, enabling efficient magnetic flux transfer and heat dissipation from the conductors to the surrounding magnetic core material.

The broadside coupling configuration shown in FIG. 3A and FIG. 3B may provide manufacturing advantages compared to concentric coil arrangements by enabling the use of planar fabrication techniques. The primary power coil 310 and the secondary coil 320 may be formed using photolithographic patterning, etching, or stamping processes that may be well-suited for high-volume production. The planar nature of the broadside coupling arrangement may facilitate automated assembly processes and may reduce the mechanical complexity associated with forming concentric coil structures.

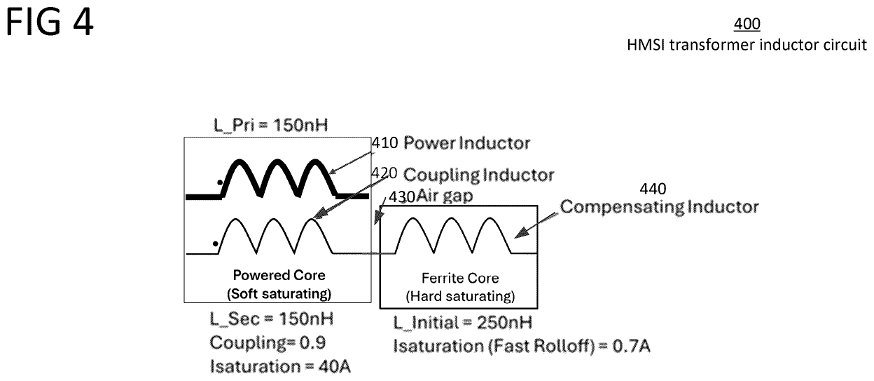

Referring to FIG. 4, a hetero magnetic swing inductor (HMSI) transformer inductor circuit 400 may provide an enhanced transformer inductor-based implementation configuration. A structure that integrates compensation functionality within the inductor structure can achieve improved efficiency and dynamic performance in mobile device applications. The HMSI transformer inductor circuit 400 may combine the magnetic coupling benefits of transformer inductors with integrated compensation features, enabling dual-state behavior based on operating current levels.

The HMSI transformer inductor circuit 400 may comprise a power inductor 410 and a coupling inductor 420 that may be magnetically coupled in a transformer configuration. The power inductor 410 may serve as the primary power-carrying element, handling the main load current in the voltage regulation circuit. The power inductor 410 may be positioned within a soft-saturating magnetic core material that may provide stable inductance characteristics during normal operating conditions while allowing gradual saturation at higher current levels.

The coupling inductor 420 may be magnetically coupled to the power inductor 410 to facilitate magnetic coupling between phases in a multi-phase converter configuration. The coupling inductor 420 may be arranged concentrically with the power inductor 410, where the coupling inductor 420 may be positioned inside the power inductor 410 and separated by a dielectric layer to maintain electrical isolation while enabling tight magnetic coupling. The concentric arrangement of the power inductor 410 and the coupling inductor 420 may achieve coupling coefficients approaching unity, enabling effective magnetic coupling for TLVR functionality.

A compensating inductor 440 may be connected in series with the coupling inductor 420 to provide integrated compensation functionality within the HMSI transformer inductor circuit 400. The compensating inductor 440 may be formed by routing select sections of the coupling inductor 420 through a ferrite core material that may exhibit hard saturation characteristics. The hard saturation properties of the ferrite core material may enable the compensating inductor 440 to exhibit dual-state inductance behavior based on the current levels flowing through the coupling inductor 420.

The compensating inductor 440 may provide high inductance values during low current conditions when the ferrite core material may remain unsaturated. During steady-state operation with low circulating currents, the compensating inductor 440 may maintain high inductance that may reduce circulating currents between phases and improve overall system efficiency. The high inductance state of the compensating inductor 440 may reduce power losses associated with circulating currents while maintaining the magnetic coupling structure needed for TLVR operation.

During transient events when current levels may increase rapidly, the ferrite core material of the compensating inductor 440 may saturate quickly due to the hard saturation characteristics. The rapid saturation of the ferrite core material may cause the inductance of the compensating inductor 440 to drop sharply, reducing the total series inductance in the coupling path. The reduced inductance may increase the effective coupling between phases, enabling faster transient response and improved voltage regulation performance during load changes.

An air gap 430 may be incorporated within the ferrite core structure of the compensating inductor 440 to control the magnetic flux path and adjust the saturation characteristics of the ferrite material. The air gap 430 may enable adjustment of the saturation threshold by controlling the magnetic flux density within the ferrite core material. The size and positioning of the air gap 430 may be selected to determine the current level at which the transition from high inductance to low inductance may occur in the compensating inductor 440.

The air gap 430 may allow designers to tune the current threshold at which the compensating inductor 440 may transition between the high inductance and low inductance states. By adjusting the dimensions of the air gap 430, the saturation threshold may be customized for specific application requirements, enabling optimization of the balance between steady-state efficiency and transient response performance. The air gap 430 may provide design flexibility that may allow the HMSI transformer inductor circuit 400 to be adapted for different current levels and performance requirements in various mobile device applications.

The ferrite material used in the compensating inductor 440 may be selected based on hard saturation behavior characteristics rather than being limited to specific ferrite compositions. The hard saturation behavior may be characterized by a rapid transition from unsaturated to saturated states as the magnetic flux density increases beyond a threshold level. Materials exhibiting hard saturation behavior may provide the sharp inductance transition needed for effective dual-state operation of the compensating inductor 440.

In some cases, the saturation threshold of the ferrite material may be adjusted by selecting different dimensions of the ferrite core structure to control when inductance drops may occur. The cross-sectional area, length, and geometry of the ferrite core material may be varied to adjust the magnetic flux density at which saturation may begin. The dimensional optimization of the ferrite core material may enable precise control of the current threshold at which the compensating inductor 440 may transition between operating states.

The thickness of the dielectric layer separating the power inductor 410 and the coupling inductor 420 may be adjusted to achieve different coupling factors between the inductors. A thinner dielectric layer may provide stronger magnetic coupling between the power inductor 410 and the coupling inductor 420, while a thicker dielectric layer may reduce the coupling strength. The dielectric thickness may be selected to optimize the coupling coefficient for the specific TLVR application requirements while maintaining adequate electrical isolation between the inductors.

The HMSI transformer inductor circuit 400 may eliminate the need for external discrete compensating inductor components by integrating the compensation functionality within the transformer inductor structure. The integrated compensation approach may reduce the overall circuit footprint and component count compared to conventional TLVR implementations that may require separate compensating inductors. The reduction in component count may provide cost savings and improved power density in mobile device applications where space constraints may be stringent.

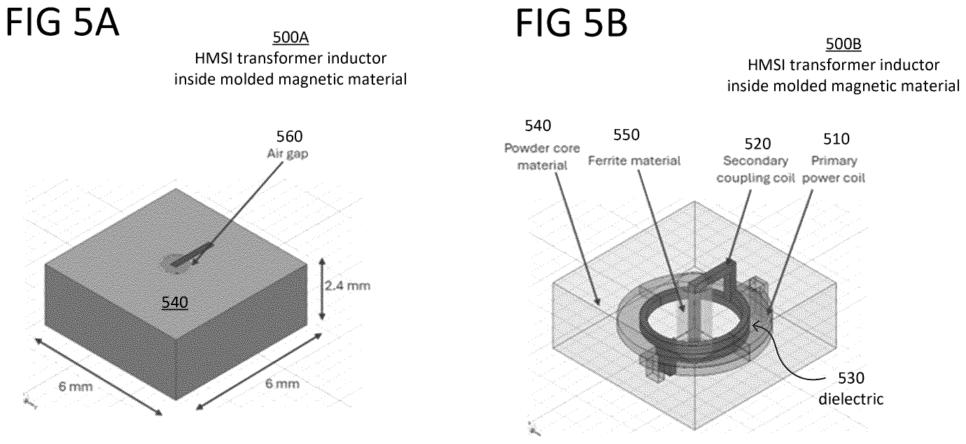

Referring to FIGS. 5A and 5B, an HMSI transformer inductor 500 (500A, 500B illustrate perspective views of a hetero magnetic swing inductor structure that integrates multiple magnetic materials to achieve variable inductance characteristics based on operating current levels. The HMSI transformer inductor 500B reveals the internal arrangement of the magnetic materials and coil elements.

The HMSI transformer inductor 500A, 500B may comprise a primary power coil 510 and a secondary coupling coil 520 arranged in a concentric configuration similar to the previously described transformer inductors. The primary power coil 510 may form an outer coil structure that carries the main power current, while the secondary coupling coil 520 may form an inner coil structure positioned concentrically within the primary power coil 510. The concentric arrangement may enable tight magnetic coupling between the primary power coil 510 and the secondary coupling coil 520 while maintaining the compact form factor suitable for mobile device applications.

A dielectric 530 may separate the primary power coil 510 from the secondary coupling coil 520 to provide electrical isolation between the two coils while maintaining close physical proximity for magnetic coupling. The dielectric 530 may comprise a thin insulating layer that may enable the HMSI transformer inductor 500A, 500B to achieve high coupling coefficients while preventing electrical short circuits between the coils. In some cases, the dielectric 530 may be formed from polyimide material, urethane material, or epoxy glass material to provide the electrical isolation characteristics needed for safe operation.

The secondary coupling coil 520 may include, or have disposed at or positioned at the center of the coil structure, a ferrite material 550 to provide hard-saturating magnetic core functionality. The ferrite material 550 may be specifically selected for hard saturation characteristics that may enable rapid transition from high inductance to low inductance states as current levels increase beyond a predetermined threshold. The ferrite material 550 may exhibit high initial permeability that may provide substantial inductance contribution during low current operation, followed by rapid saturation that may cause sharp inductance reduction during high current transient events.

An air gap 560 may be incorporated within or adjacent to the ferrite material 550 to control the magnetic flux path and adjust the saturation characteristics of the secondary coupling coil 520. The air gap 560 may enable precise tuning of the current threshold at which the ferrite material 550 may transition from unsaturated to saturated states. The size and positioning of the air gap 560 may be selected to optimize the saturation threshold for specific application requirements, allowing designers to customize the current level at which the inductance transition may occur.

The air gap 560 may provide design flexibility by allowing adjustment of the magnetic flux density within the ferrite material 550. A larger air gap 560 may increase the current threshold required to saturate the ferrite material 550, while a smaller air gap 560 may enable saturation at lower current levels. The air gap 560 may be formed during the manufacturing process by creating a controlled void or by inserting a non-magnetic spacer material within the ferrite material 550 structure.

A powder core material 540 may surround the entire coil assembly comprising the primary power coil 510, the secondary coupling coil 520, and the dielectric 530 to provide the magnetic flux path for the primary power coil 510. The powder core material 540 may comprise a soft-saturating magnetic material, such as powdered iron or a composite magnetic material, which provides stable inductance characteristics for the primary power coil 510 during normal operating conditions. The soft saturation characteristics of the powder core material 540 may enable gradual inductance reduction at higher current levels while maintaining adequate magnetic permeability throughout the operating range.

The combination of the ferrite material 550 within the secondary coupling coil 520 and the powder core material 540 surrounding the entire structure may create a hetero-magnetic configuration that exhibits different magnetic behaviors under varying current conditions. During low current operation, both the ferrite material 550 and the powder core material 540 may remain unsaturated, providing high inductance values for both the primary power coil 510 and the secondary coupling coil 520. The high inductance state may reduce circulating currents between phases in a multi-phase converter configuration, improving overall system efficiency during steady-state operation.

During transient events when current levels may increase rapidly, the ferrite material 550 may saturate quickly due to the hard saturation characteristics, causing the inductance contribution from the ferrite material 550 to drop sharply. The rapid saturation of the ferrite material 550 may reduce the total inductance of the secondary coupling coil 520, thereby increasing the effective coupling between phases and enabling a faster transient response. The powder core material 540 may continue to provide a magnetic flux path for the primary power coil 510, maintaining the power handling capability while the ferrite material 550 transitions between inductance states.

The hetero-magnetic configuration may enable the HMSI transformer inductor 500A, 500B to achieve both high efficiency during steady-state operation and effective transient performance during load changes. The dual magnetic material approach may eliminate the need for external compensating inductors by integrating the compensation functionality within the transformer inductor structure. The integrated compensation may reduce component count and circuit footprint compared to conventional TLVR implementations that may require separate discrete compensating components.

The HMSI transformer inductor 500A, 500B may be manufactured with packaging heights suitable for mobile device applications, typically less than 3 mm, while achieving inductance values in the range of 150-250 nH. The compact form factor combined with the variable inductance characteristics may enable mobile devices to achieve improved power delivery performance while meeting stringent size and height constraints typical of ultra-thin laptops and tablets.

In some cases, the ferrite material 550 may be selected based on specific saturation flux density characteristics that may determine the current threshold for inductance transition. Ferrite materials with saturation flux density values around 0.342 Wb/m² and initial permeability values around 500 may provide suitable characteristics for mobile device applications. The ferrite material 550 may maintain stable inductance values up to current levels around 0.7 amperes before exhibiting rapid saturation and inductance reduction.

The powder core material 540 may be selected to complement the characteristics of the ferrite material 550 by providing stable magnetic properties for the primary power coil 510 throughout the operating current range. The powder core material 540 may comprise materials with higher saturation flux density compared to the ferrite material 550, enabling the primary power coil 510 to handle higher current levels while maintaining adequate inductance values. The combination of different magnetic materials may enable the HMSI transformer inductor 500A, 500B to optimize both steady-state efficiency and transient response performance in a single integrated component.

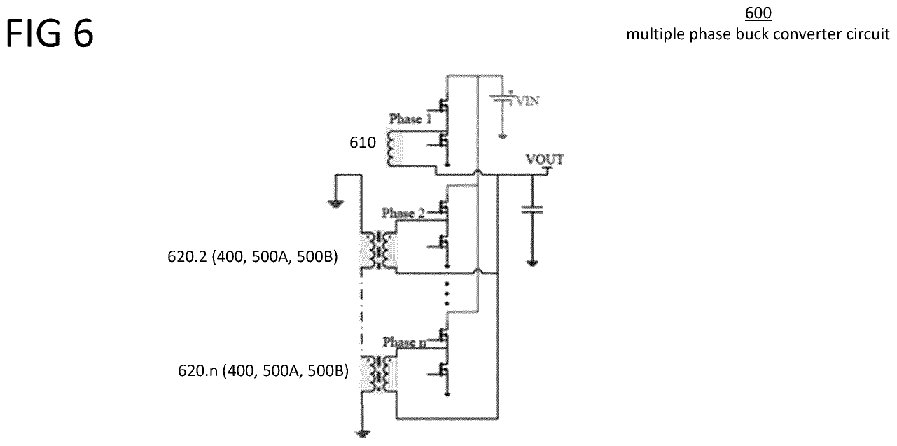

Referring to FIG. 6, a multiple-phase buck converter circuit 600 may incorporate HMSI transformer inductors 400, 500A, 500B to provide enhanced power delivery performance in mobile device applications. The multiple-phase buck converter circuit 600 may demonstrate how the HMSI transformer inductor circuit 400 may be implemented in a practical voltage regulation system that combines multiple phases to deliver current to a load while achieving both steady-state efficiency and responsive transient performance.

The multiple-phase buck converter circuit 600 may comprise a first-phase inductor 610, which is configured as a single inductor element connected between the switching node of Phase 1 and the output voltage node. The first-phase inductor 610 may provide a higher inductance value compared to the other phases in the multiple-phase buck converter circuit 600, which provides better efficiency at light loading in the range of No Load to ˜20 A. During the DCM (Discontinuous Conduction Mode) operation of the first phase, the controller may employ some more tweaks like ton interval manipulation to eek out more efficiency. In some cases, the first-phase inductor 610 may be implemented as a conventional single inductor without the HMSI functionality.

A second-phase HMSI transformer inductor 620.2 may be incorporated into the multiple-phase buck converter circuit 600 to provide the integrated compensation functionality described in the HMSI transformer inductor circuit 400. The second phase HMSI transformer inductor 620.2 may include both the primary power coil 510 and the secondary coupling coil 520 arranged in the concentric configuration with the ferrite material 550 and the powder core material 540. The primary power coil 510 of the second-phase HMSI transformer inductor 620.2 may be connected between a switching node of Phase 2 and the output voltage node to carry the power current for the second phase.

An nth phase HMSI transformer inductor 620.n may represent additional phases in the multiple-phase buck converter circuit 600, where n may indicate the total number of phases in the system. The nth phase HMSI transformer inductor 620.n may be configured similarly to the second phase HMSI transformer inductor 620.2, with the primary power coil 510 connected between a switching node of Phase n and the output voltage node. The multiple phase configuration may enable the system to handle higher total current levels while distributing the current load across multiple phases to improve thermal management and reduce current stress on individual components.

A secondary coupling coil 520 from each of the HMSI transformer inductors may be connected in series to form a coupling path that links the multiple phases together. The series connection of the secondary coupling coils 520 may enable magnetic coupling between phases that may facilitate current sharing and transient response improvement during load changes. The series-connected secondary coupling coils 520 may create a common coupling path that may allow rapid current redistribution between phases when load transients occur, enabling faster voltage regulation response compared to uncoupled multi-phase systems.

Each phase in the multiple-phase buck converter circuit 600 may include switching elements positioned between an input voltage node and ground, with switching nodes connected to the respective inductors. The switching elements may operate in a sequential manner to deliver current to the load through the multiple phases, with the timing of the switching events coordinated to reduce output voltage ripple and optimize power delivery efficiency. A capacitor may be connected between the output voltage node VOUT and ground to provide filtering and energy storage for the multi-phase system.

The HMSI transformer inductor circuit 400 may operate within the multiple-phase buck converter circuit 600 to provide dual-state behavior that may optimize both steady-state efficiency and transient response performance. During steady-state operation, the ferrite material 550 within each secondary coupling coil 520 may remain unsaturated, providing high inductance values that may reduce circulating current ripple between phases. The high inductance state may reduce power losses associated with phase-to-phase current circulation, improving overall system efficiency during normal operating conditions.

During transient events when load current may change rapidly, the ferrite material 550 may saturate quickly due to the hard saturation characteristics, causing the inductance of the secondary coupling coils 520 to drop sharply. The reduced inductance may increase the effective coupling between phases through the series-connected secondary coupling coils 520, enabling faster current redistribution and improved transient response. The rapid inductance transition may allow the multiple-phase buck converter circuit 600 to respond quickly to load changes while maintaining stable output voltage regulation.

The series connection of the secondary coils 520 may eliminate the need for external discrete compensating inductor components that may otherwise be required in conventional TLVR implementations. The integrated compensation functionality provided by the HMSI transformer inductors may reduce the overall component count and circuit footprint compared to systems that may require separate compensating inductors. The reduction in component count may provide cost savings and improved power density in mobile device applications where space constraints may be stringent.

The multiple-phase buck converter circuit 600 may achieve improved bandwidth and settling time characteristics compared to conventional multi-phase systems through the integrated compensation functionality of the HMSI transformer inductors. The rapid inductance transition during transient events may enable faster voltage regulation response, reducing the settling time required to reach steady-state output voltage following load changes. The improved transient response may enable the use of smaller output capacitors, further reducing the overall system size and cost.

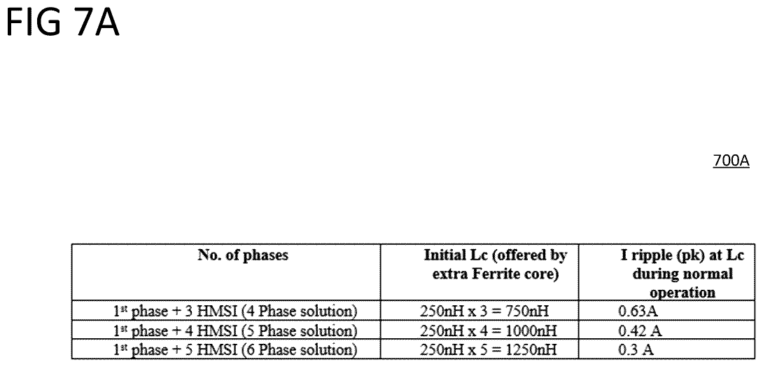

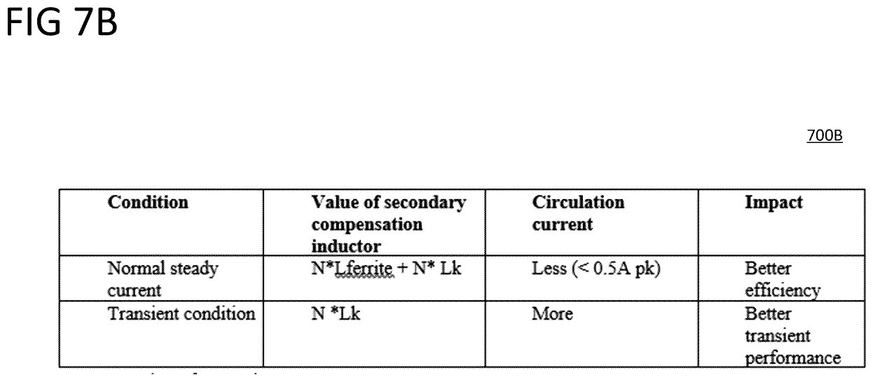

Referring to FIG. 7A, a table 700A illustrates the relationship between the number of phases in a multi-phase converter system, the initial inductance provided by the ferrite material 550, and the peak ripple current characteristics during normal operation. The table 700A demonstrates how the total compensation inductance may scale with the number of HMSI transformer inductors incorporated into the multiple-phase buck converter circuit 600, while simultaneously showing the corresponding reduction in ripple current that may be achieved through increased phase count.

The table 700A shows that a 4-phase solution comprising the first-phase inductor 610 plus three HMSI transformer inductors may provide a total initial compensation inductance of 750 nH. This total compensation inductance may be calculated as 250 nH multiplied by three HMSI transformer inductors, where each HMSI transformer inductor may contribute 250 nH of inductance through the ferrite material 550 within the secondary coupling coil 520. The 4-phase configuration may exhibit a peak ripple current of 0.63 amperes at the compensation inductor during normal steady-state operation.

The table 700A further demonstrates that a 5-phase solution comprising the first-phase inductor 610 plus four HMSI transformer inductors provides a total initial compensation inductance of 1000 nH. The increased total compensation inductance results from the addition of a fourth HMSI transformer inductor, where 250 nH multiplied by four HMSI transformer inductors may yield the 1000 nH total value. The 5-phase configuration achieves a reduced peak ripple current of 0.42 amperes at the compensation inductor during normal operation, demonstrating the ripple current reduction benefit that may be obtained through increased phase count.

A 6-phase solution is shown in the table 700A as comprising the first-phase inductor 610 plus five HMSI transformer inductors, providing a total initial compensation inductance of 1250 nH. The 6-phase configuration represents the highest phase count illustrated in the table 700A, where 250 nH multiplied by five HMSI transformer inductors produces the 1250 nH total compensation inductance. The 6-phase solution achieves the lowest peak ripple current of 0.3 amperes at the compensation inductor during normal operation, illustrating the continued ripple current reduction that may be achieved through further increases in phase count.

The data presented in table 700A demonstrates an inverse relationship between the number of phases and the peak ripple current levels. As the number of HMSI transformer inductors increases from three to five, the peak ripple current may decrease from 0.63 amperes to 0.3 amperes, representing a substantial reduction in ripple current amplitude. The ripple current reduction results from the increased total compensation inductance and the improved current distribution across the additional phases in the multiple-phase buck converter circuit 600.

The compensation inductance values shown in table 700A is provided by the ferrite material 550 within each secondary coupling coil 520 during low current operation when the ferrite material 550 may remain unsaturated. The 250 nH contribution from each HMSI transformer inductor may represent the inductance value that may be maintained during steady-state operation before the ferrite material 550 may begin to saturate at higher current levels. The consistent 250 nH contribution from each HMSI transformer inductor may enable predictable scaling of the total compensation inductance based on the number of phases selected for a particular application.

The peak ripple current values presented in table 700A establish the saturation current requirements for the ferrite material 550 in each HMSI transformer inductor. The ferrite material 550 maintains stable inductance characteristics at current levels exceeding the peak ripple current values to ensure proper operation during normal steady-state conditions. In some cases, the saturation current of the ferrite material 550 may be selected to be greater than 0.7 amperes to provide an adequate margin above the highest peak ripple current value of 0.63 amperes shown in the 4-phase configuration.

Table 700A provides design guidance for selecting the appropriate number of phases based on the desired balance between component count, total compensation inductance, and ripple current performance. Applications requiring lower ripple current levels may benefit from higher phase counts, while those with less stringent ripple current requirements can achieve adequate performance with fewer phases and a reduced component count. The scalable nature of the HMSI transformer inductor approach may enable designers to optimize the phase count for specific application requirements while maintaining the integrated compensation functionality.

Referring to FIG. 7B, table 700B summarizes the behavior and impact of the secondary compensation inductor under different operating conditions, demonstrating how the HMSI transformer inductor circuit 400 may achieve dual-state performance characteristics that optimize both steady-state efficiency and transient response. Table 700B illustrates the relationship between operating conditions, the effective inductance value of the secondary compensation inductor, the resulting circulation current levels, and the corresponding impact on system performance.

Table 700B shows that during normal steady current conditions, the value of the secondary compensation inductor may be expressed as N*Lferrite+N*Lk, where the total inductance may comprise contributions from both the ferrite material 550 and the leakage inductance components. During steady-state operation, the ferrite material 550 within each secondary coupling coil 520 may remain unsaturated, providing the full Lferrite inductance contribution from each HMSI transformer inductor. The leakage inductance Lk may represent the inherent inductance present at the secondary coupling coil 520 that may exist independently of the ferrite material 550 saturation state.

The parameter N in table 700B may represent the number of TLVR phases incorporated into the multiple-phase buck converter circuit 600, indicating how the total compensation inductance may scale with the number of HMSI transformer inductors connected in series. In a multi-phase configuration, the series connection of the secondary coupling coils 520 may result in additive inductance contributions from each phase, where the total inductance may be the sum of the individual inductance contributions multiplied by the number of phases.

During normal steady current operation, table 700B indicates that the circulation current ripple remains at levels less than 0.5 amperes peak, representing the low circulating current state that may be achieved when the ferrite material 550 provides high inductance values. The low circulation current may result from the high total inductance value N*Lferrite+N*Lk that may limit current flow through the series-connected secondary coupling coils 520. The reduced circulation current may reduce power losses associated with phase-to-phase current circulation, resulting in better efficiency during steady-state operation as indicated in the impact column of table 700B.

Table 700B further demonstrates that during transient conditions, the value of the secondary compensation inductor may be reduced to N*Lk, representing the inductance state when the ferrite material 550 may become saturated. During transient events when current levels may increase rapidly, the hard saturation characteristics of the ferrite material 550 may cause the Lferrite contribution to drop significantly, leaving primarily the leakage inductance Lk as the dominant inductance component in each secondary coupling coil 520.

The reduction in total inductance from N*Lferrite+N*Lk to N*Lk during transient conditions may result in increased circulation current ripple through the series-connected secondary coils 500, as indicated by the “More” circulation current entry in table 700B. The increased circulation current may enable faster current redistribution between phases in the multiple-phase buck converter circuit 600, facilitating rapid response to load changes and resulting in better transient performance, as shown in the impact column.

The leakage inductance Lk may represent the inductance component that may remain present at the secondary coupling coil 520 even when the ferrite material 550 is fully saturated. The leakage inductance Lk may result from the magnetic flux that may not be fully coupled through the ferrite material 550, including flux paths through the powder core material 540 and air gap 560 within the magnetic structure. The leakage inductance Lk may provide a minimum inductance value that may maintain some level of magnetic coupling between phases even during transient conditions when the ferrite material 550 may be saturated.

The Lferrite parameter in table 700B represents the inductance contribution specifically provided by the ferrite material 550 within each secondary coupling coil 520. The Lferrite value may be determined by the magnetic properties of the ferrite material 550, including the initial permeability, saturation flux density, and the physical dimensions of the ferrite core structure. The Lferrite contribution may be the primary variable component that may change between the normal steady current and transient conditions, enabling the dual-state behavior of the HMSI transformer inductor circuit 400.

The table 700B demonstrates how the HMSI transformer inductor circuit 400 may achieve the dual objectives of high efficiency during steady-state operation and responsive transient performance during load changes through the variable inductance characteristics of the ferrite material 550. The automatic transition between high inductance and low inductance states based on current levels may eliminate the need for external control circuits or switching elements to achieve the dual-state behavior, simplifying the overall system design while providing enhanced performance characteristics.

The impact entries in table 700B illustrate the trade-off between efficiency and transient response that may be optimized through the HMSI approach. During normal operation, the high inductance state may prioritize efficiency by reducing circulation current ripple and associated power losses. During transient events, the low inductance state may prioritize transient response by enabling rapid current redistribution between phases, demonstrating how the HMSI transformer inductor circuit 400 may automatically adapt its behavior to match the instantaneous performance requirements of the power delivery system.

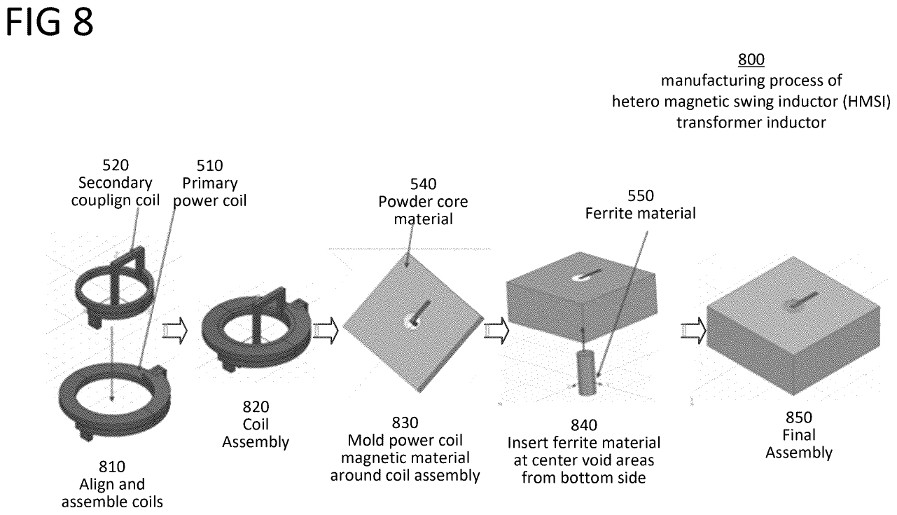

Referring to FIG. 8, a manufacturing process 800 may provide a systematic approach for constructing the HMSI transformer inductor through sequential assembly steps that integrate the concentric coil structure with the hetero magnetic core materials. The manufacturing process 800 demonstrates how the primary power coil 510 and the secondary coupling coil 520 may be combined with the power core material 540 and the ferrite material 550 to create the HMSI structure with integrated compensation functionality.

The manufacturing process 800 may begin with a step 810 where the primary power coil 510 and the secondary coupling coil 520 may be aligned and assembled in the concentric configuration. During the step 810, the secondary coupling coil 520 may be positioned concentrically within the primary power coil 510 while maintaining the dielectric separation between the conductors. The alignment process in the step 810 may ensure that the primary power coil 510 and the secondary coupling coil 520 may be properly positioned to achieve the desired magnetic coupling characteristics while maintaining electrical isolation through the dielectric layer.

The step 810 may involve precise mechanical positioning to maintain consistent spacing between the primary power coil 510 and the secondary coupling coil 520 throughout the concentric structure. In some cases, the step 810 may include the application of the dielectric material to one or both coil surfaces to ensure electrical isolation during the assembly process. The step 810 may utilize alignment fixtures or tooling to maintain the concentric positioning while the coils are being assembled, ensuring that the geometric relationships needed for improved magnetic coupling may be preserved.

Following the initial alignment, the manufacturing process 800 may proceed to a step 820 where a coil assembly may be formed from the aligned primary power coil 510 and secondary coupling coil 520. The step 820 may involve securing the concentric coil arrangement to maintain the positioning established during the step 810. In some cases, the step 820 may include temporary bonding or mechanical fixturing to hold the primary power coil 510 and the secondary coupling coil 520 in the proper concentric relationship during subsequent manufacturing operations.

The step 820 may ensure that the coil assembly maintains the dimensional tolerances needed for consistent magnetic coupling performance across multiple units during high-volume production. The coil assembly formed during the step 820 may include provisions for the subsequent insertion of the ferrite material 550, such as maintaining a central void area within the secondary coupling coil 520 that may accommodate the ferrite core structure. The step 820 may also involve preparation of the coil leads to facilitate electrical connections in the final HMSI structure.

The manufacturing process 800 may then advance to a step 830 where the power core material 550 may be molded around the coil assembly formed in the step 820. The step 830 may involve positioning the coil assembly within a molding fixture and introducing the power core material 550 in a flowable state that may surround the primary power coil 510 and the secondary coupling coil 520. The molding operation in the step 830 may ensure intimate contact between the power core material 550 and the coil surfaces to facilitate efficient magnetic flux transfer and heat dissipation.

During the step 830, the power core material 550 may be introduced through injection molding, compression molding, or other suitable molding techniques that may provide complete encapsulation of the coil assembly while maintaining the central void area needed for subsequent ferrite insertion. The step 830 may include curing or sintering processes that may solidify the power core material 550 and establish the final magnetic properties of the soft-saturating core material. The molding process in the step 830 may be controlled to maintain the dimensional accuracy of the central void area that may accommodate the ferrite material 550.

The manufacturing process 800 may then proceed to a step 840 where the ferrite material 550 may be inserted at the center void area from the bottom side of the molded structure. The step 840 may involve positioning the ferrite material 550 within the central void area that may have been preserved during the step 830. The insertion process in the step 840 may ensure that the ferrite material 550 may be properly positioned within the secondary coupling coil 520 to provide the hard saturation characteristics needed for the dual-state inductance behavior.

The step 840 may include the formation of the air gap 560 within or adjacent to the ferrite material 550 to control the saturation characteristics of the compensation inductor functionality. In some cases, the step 840 may involve the insertion of pre-formed ferrite core pieces that may include the air gap 560, or the air gap 560 may be created during the insertion process through controlled spacing or the placement of non-magnetic spacer materials. The step 840 may ensure that the ferrite material 550 may be securely positioned within the central void area to maintain the desired magnetic properties throughout the operating life of the HMSI.

The step 840 may utilize insertion techniques that may reduce mechanical stress on the previously molded power core material 550 while ensuring proper positioning of the ferrite material 550. The insertion process may be performed from the bottom side to facilitate automated assembly processes and to ensure that the ferrite material 550 may be properly seated within the central void area. The step 840 may include verification procedures to confirm that the ferrite material 550 may be correctly positioned and that the air gap 560 may have the desired dimensions for the intended saturation characteristics.

The manufacturing process 800 may conclude with a step 850, which may represent the final assembly of the HMSI. The step 850 may involve completing the encapsulation of the ferrite material 550 and finalizing the external form factor of the HMSI structure. In some cases, the step 850 may include additional molding operations to seal the bottom opening created during the ferrite insertion process in the step 840, ensuring that the ferrite material 550 may be enclosed within the overall magnetic structure.

The step 850 may include the exposure and trimming of the coil leads to enable electrical connections to the primary power coil 510 and the secondary coupling coil 520. The lead preparation during the step 850 may involve removing excess molding material from the connection areas and forming the leads to the appropriate dimensions for surface-mount device assembly. The step 850 may also include electrical testing to verify the inductance values, coupling coefficients, and saturation characteristics of the completed HMSI structure.

The step 850 may involve final quality assurance procedures that may verify the mechanical and electrical characteristics of the HMSI structure. The final assembly process in the step 850 may include dimensional inspection to ensure that the overall package dimensions may meet the requirements for mobile device applications, including the z-height constraints that may be important for ultra-thin laptop and tablet implementations. The step 850 may conclude with packaging the completed HMSI as a surface-mount device ready for integration into mobile device power delivery systems.

The sequential nature of the manufacturing process 800 may enable the integration of the concentric coil structure with the hetero magnetic core materials through controlled assembly steps that may maintain the precise geometric relationships needed for improved performance. The manufacturing process 800 may be compatible with high-volume production techniques while providing the flexibility to adjust the magnetic characteristics through variations in the ferrite material 550 selection and air gap 560 dimensions. The systematic approach demonstrated by the manufacturing process 800 may ensure consistent performance characteristics across production units while maintaining the compact form factor suitable for mobile device applications.

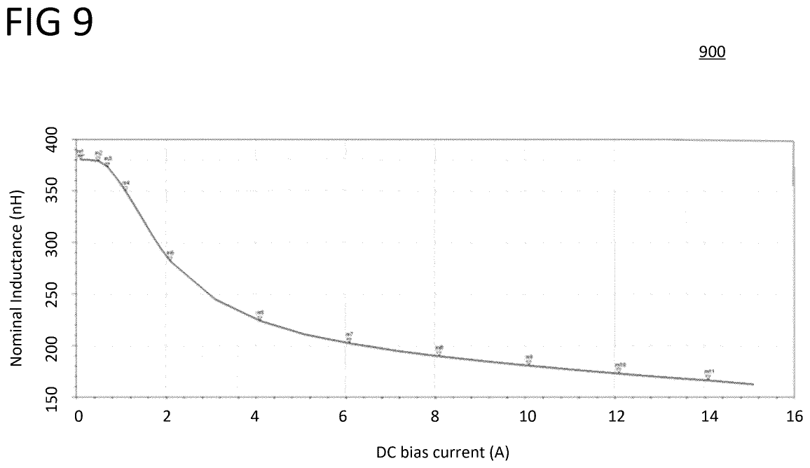

Referring to FIG. 9, a graph 900 illustrates the relationship between nominal inductance and DC bias current for the secondary coupling coil 520 with integrated ferrite material 550, demonstrating the dual-state inductance characteristics that enable the HMSI transformer inductor circuit 400 to achieve both steady-state efficiency and responsive transient performance. The graph 900 shows nominal inductance measured in nanohenries plotted against DC bias current measured in amperes, revealing the distinctive two-step inductance behavior that results from the hard saturation characteristics of the ferrite material 550.

The graph 900 demonstrates that the nominal inductance of the secondary coupling coil 520 remains stable at approximately 375 nanohenries (nH) for low current values extending up to about 0.7 amperes (A), 210 nH is contributed by hard saturation ferrite material, which is added in the middle, and 165 nH is contributed by the secondary coil. This stable high-inductance region may represent the operating range where the ferrite material 550 remains unsaturated, providing its full magnetic permeability contribution to the total inductance of the secondary coupling coil 520. The ˜375 nH inductance value during this stable region may correspond to the design targets referenced in table 700A and confirmed by Maxwell simulation results, indicating that the ferrite material 550 may maintain consistent inductance characteristics within the unsaturated operating range.

The stable inductance plateau shown in the graph 900 may enable the HMSI transformer inductor circuit 400 to maintain high inductance values during steady-state operation when circulating currents between phases may remain below the 0.7 ampere threshold. During normal operating conditions, the low circulating currents may keep the ferrite material 550 in the unsaturated state, allowing the secondary coupling coil 520 to provide the full 379 nH inductance contribution. Total secondary inductance for N N-phase designs is N times 379 nH. The high inductance state may reduce circulating currents between phases in the multiple-phase buck converter circuit 600, reducing power losses and improving overall system efficiency during steady-state operation.

As shown in the graph 900, the inductance of the secondary coupling coil 520 may begin to decrease steeply after the DC bias current exceeds approximately 0.7 amperes. The rapid inductance reduction may result from the hard saturation characteristics of the ferrite material 550, which may cause the magnetic permeability of the ferrite core to drop significantly once the saturation threshold may be reached. The steep transition from high inductance to low inductance may occur over a relatively narrow current range, demonstrating the hard saturation behavior that enables the dual-state functionality of the HMSI transformer inductor circuit 400.

The graph 900 further shows that the inductance of the secondary coupling coil 520 may continue to decline as the DC bias current increases beyond the saturation threshold, eventually reaching approximately 165 nH at 14 amperes. The reduced inductance value of 165 nH at higher current levels represents the inductance contribution that remains when the ferrite material 550 may be fully saturated. The residual inductance may result from the leakage inductance components and the magnetic flux paths through the power core material 550 that may not be dependent on the ferrite material 550 saturation state.

The two-step inductance characteristic demonstrated in the graph 900 enables the HMSI transformer inductor circuit 400 to automatically adapt its behavior based on the instantaneous current levels flowing through the secondary coupling coil 520. During transient events when load current may change rapidly, the increased circulating currents may exceed the 0.7 ampere threshold, causing the ferrite material 550 to saturate and the inductance to drop from 379 nH to approximately 165 nH. The reduced inductance may increase the effective coupling between phases in the multiple-phase buck converter circuit 600, enabling faster current redistribution and improved transient response.

The current threshold of approximately 0.7 amperes shown in the graph 900 is consistent with the saturation current requirements established in the table 700A, where the ferrite material 550 maintains stable inductance characteristics at current levels exceeding the peak ripple current values. The 0.7 ampere threshold provides adequate margin above the highest peak ripple current value of 0.63 amperes shown in the 4-phase configuration, ensuring that the ferrite material 550 remains unsaturated during normal steady-state operation while transitioning to the saturated state during transient conditions.

The steep inductance transition shown in the graph 900 may result from the specific magnetic properties of the ferrite material 550, including the saturation flux density and initial permeability characteristics. The ferrite material 550 may be selected to exhibit hard saturation behavior that may provide the rapid transition between inductance states needed for effective dual-state operation. The hard saturation characteristics may enable the HMSI transformer inductor circuit 400 to achieve distinct operating modes for steady-state efficiency and transient response without requiring external control circuits or switching elements.

The graph 900 demonstrates that the ferrite material 550 maintains the high inductance value of 379 nH throughout the low current operating range, providing consistent compensation characteristics during steady-state operation. The stable inductance plateau may ensure that the HMSI transformer inductor circuit 400 provides predictable efficiency benefits during normal operating conditions, while the steep transition to the low inductance state may ensure responsive transient performance when load changes occur. The dual-state behavior shown in the graph 900 enables the HMSI approach to achieve both high efficiency and fast transient response in a single integrated component suitable for mobile device applications.

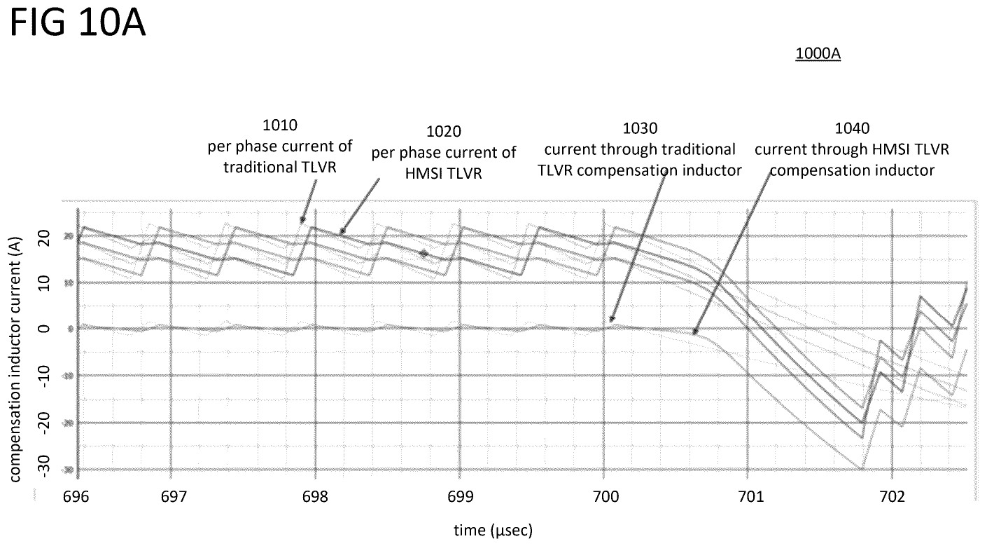

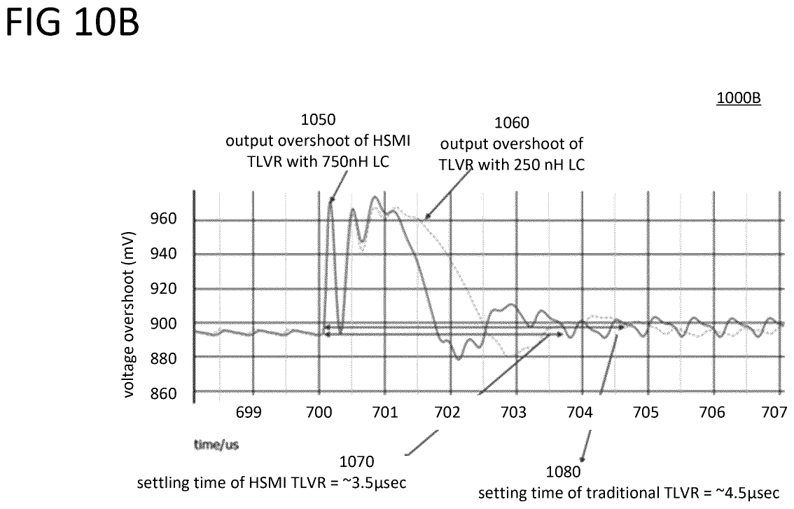

Referring to FIG. 10A, graph 1000A illustrates current waveforms over time for traditional TLVR and HMSI TLVR configurations, demonstrating the comparative performance characteristics between conventional transformer inductor voltage regulator implementations and the enhanced HMSI approach during steady-state operation. The graph 1000A provides time-domain analysis of current behavior that reveals the efficiency advantages achieved through the integrated compensation functionality of the HMSI transformer inductor circuit 400.

The graph 1000A displays a per-phase current of traditional TLVR 1010 that exhibits characteristic ripple current behavior typical of conventional TLVR implementations. The per-phase current of traditional TLVR 1010 shows current waveforms with substantial ripple amplitude during steady-state operation, where the current oscillates between peak and valley values as the switching elements in each phase operate in sequence. The ripple amplitude of the per-phase current of traditional TLVR 1010 results from the fixed inductance characteristics of conventional transformer inductors that do not adapt to varying operating conditions.

In contrast, the graph 1000A shows a per-phase current of HMSI TLVR 1020 that demonstrates reduced ripple amplitude compared to the per-phase current of traditional TLVR 1010 during steady-state operation. The per-phase current of HMSI TLVR 1020 exhibits smoother current waveforms with lower peak-to-peak variation, indicating improved current regulation characteristics achieved through the dual-state inductance behavior of the ferrite material 550. The reduced ripple amplitude of the per-phase current of HMSI TLVR 1020 results from the higher inductance values provided by the ferrite material 550 during steady-state operation, when circulating currents may remain below the saturation threshold.

The graph 1000A further illustrates a current through traditional TLVR compensation inductor 1030 that represents the circulating current behavior in conventional TLVR systems that require external discrete compensating inductors. The current through the traditional TLVR compensation inductor 1030 shows higher magnitude current levels that results from the fixed inductance characteristics of external compensating components. The higher circulating current levels associated with the current through traditional TLVR compensation inductor 1030 contributes to increased power losses and reduced overall system efficiency during steady-state operation.

The graph 1000A demonstrates a current through HMSI TLVR compensation inductor 1040 that exhibits significantly lower magnitude compared to the current through traditional TLVR compensation inductor 1030. The current through the HMSI TLVR compensation inductor 1040 shows reduced circulating current levels that results from the high inductance state of the ferrite material 550 during steady-state operation. The lower magnitude of the current through HMSI TLVR compensation inductor 1040 indicates that the integrated compensation functionality of the HMSI transformer inductor circuit 400 effectively reduces circulating currents between phases, reducing power losses associated with phase-to-phase current circulation.

The comparative current waveforms shown in the graph 1000A demonstrate that the HMSI TLVR configuration achieves improved efficiency characteristics compared to traditional TLVR implementations through the reduction of both per-phase ripple current and compensation inductor circulating current. The reduced ripple amplitude of the per-phase current of HMSI TLVR 1020 results in lower switching losses in the power switching elements and reduced core losses in the magnetic components. The lower magnitude of the current through HMSI TLVR compensation inductor 1040 reduces conduction losses and core losses associated with the compensation functionality.

The efficiency improvements demonstrated in graph 1000A results from the automatic adaptation of the ferrite material 550 inductance characteristics based on operating current levels. During steady-state operation with low circulating currents, the ferrite material 550 remains unsaturated, providing high inductance values that may reduce both per-phase ripple current and compensation inductor circulating current. The high inductance state enables the HMSI transformer inductor circuit 400 to achieve superior steady-state efficiency compared to conventional TLVR implementations that may not provide variable inductance characteristics.

The reduced current levels shown in the graph 1000A for both the per-phase current of HMSI TLVR 1020 and the current through HMSI TLVR compensation inductor 1040 contribute to improved thermal performance in mobile device applications where heat dissipation may be constrained by compact form factors. The lower current ripple and reduced circulating currents result in decreased power dissipation in both the magnetic components and the power switching elements, enabling the power delivery system to operate at lower temperatures while maintaining the same power delivery capability.

The graph 1000A further demonstrates that the HMSI approach provides efficiency benefits during steady-state operation while maintaining the capability for enhanced transient response when load conditions may change rapidly. The dual-state behavior of the ferrite material 550 enables the HMSI transformer inductor circuit 400 to automatically transition from the high-efficiency steady-state mode to a responsive transient mode when current levels exceed the saturation threshold, providing improved performance characteristics for both operating conditions without requiring external control circuits or switching elements.

Referring to FIG. 10B, a graph 1000B may illustrate voltage overshoot characteristics during transient events for different TLVR configurations, demonstrating the comparative transient response performance between conventional TLVR implementations and the enhanced HMSI approach. The graph 1000B may show voltage overshoot measured in millivolts plotted against time measured in microseconds, revealing how the dual-state inductance behavior of the ferrite material 550 may enable improved transient response characteristics while maintaining the efficiency benefits demonstrated in the graph 1000A.

The graph 1000B displays an output overshoot of HMSI TLVR with 750 nH LC 1050 that represents the voltage regulation response of the HMSI transformer inductor circuit 400 during a transient load change event. The output overshoot of HMSI TLVR with 750 nH LC 1050 demonstrates the voltage excursion characteristics that occur when the load current changes rapidly, causing the ferrite material 550 to transition from the high inductance state to the low inductance state. The 750 nH LC value represents the total compensation inductance provided by the series-connected secondary coils 500 in a multi-phase configuration, such as the 3-phase solution shown in the table 700A where three HMSI transformer inductors may contribute 250 nH each.

In comparison, the graph 1000B shows an output overshoot of TLVR with 250 nH LC 1060 that represents the voltage regulation response of a conventional TLVR implementation with a fixed 250 nH external compensation inductor. The output overshoot of TLVR with 250 nH LC 1060 demonstrates the transient response characteristics of traditional TLVR systems that do not provide the variable inductance behavior of the HMSI approach. The fixed 250 nH compensation inductance represents a conventional external discrete compensating inductor that does not adapt to varying current conditions during transient events.

The graph 1000B demonstrates that both the output overshoot of HMSI TLVR with 750 nH LC 1050 and the output overshoot of TLVR with 250 nH LC 1060 achieve similar peak overshoot magnitudes during the transient event, indicating that both configurations provide comparable same kind of transient response. The similar peak overshoot values demonstrate that the HMSI approach may maintain the transient response capability of conventional TLVR implementations while providing the additional efficiency benefits at light load shown in the graph 1000A through the dual-state inductance behavior.

A settling time at 1070 indicates that the settling time of the HMSI TLVR is approximately 3.5 microseconds, representing the time required for the output voltage to return to steady-state levels following the transient event. The settling time at 1070 demonstrates that the HMSI transformer inductor circuit 400 achieves faster settling characteristics compared to conventional TLVR implementations, enabling the output voltage to stabilize more rapidly after load changes. The improved settling time indicated at 1070 results from the rapid transition of the ferrite material 550 from the saturated state back to the unsaturated state as current levels decrease following the transient event.

Settling time at 1080 indicates that the settling time of the traditional TLVR is approximately 4.5 microseconds, representing a longer stabilization period compared to the HMSI approach. The settling time at 1080 demonstrates that conventional TLVR implementations with fixed compensation inductance may require additional time to achieve steady-state voltage regulation following transient events. The longer settling time 1080 results from the fixed inductance characteristics of conventional compensation inductors that do not provide the adaptive behavior of the ferrite material 550 in the HMSI transformer inductor circuit 400.

The comparison between the settling time at 1070 and the settling time at 1080 demonstrates that the HMSI TLVR achieves approximately 22% faster settling time compared to traditional TLVR implementations, representing a significant improvement in transient response performance. The faster settling time enables the HMSI approach to provide superior voltage regulation bandwidth compared to conventional TLVR systems, allowing for more responsive power delivery in mobile device applications where rapid load changes may occur frequently due to varying processor workloads and power management operations.

The improved settling time characteristics shown in the graph 1000B result from the automatic adaptation of the ferrite material 550 inductance during transient recovery. As the load current decreases following a transient event, the ferrite material 550 transitions from the saturated low inductance state back to the unsaturated high inductance state, providing enhanced damping that accelerate the return to steady-state conditions. The rapid inductance transition enables the HMSI transformer inductor circuit 400 to optimize the transient recovery characteristics while maintaining the efficiency benefits during subsequent steady-state operation.

The graph 1000B further demonstrates that the HMSI approach achieves both improved transient response and enhanced efficiency compared to traditional TLVR implementations through the integrated dual-state behavior of the ferrite material 550. During the transient event, the ferrite material 550 saturates rapidly, reducing the compensation inductance and enabling faster current redistribution between phases for improved transient response. Following the transient event, the ferrite material 550 returns to the unsaturated state, providing high inductance that may reduce circulating currents and improve efficiency during steady-state operation.

The combination of faster settling time indicated by the annotation 1070 and the efficiency improvements demonstrated in the graph 1000A enable the HMSI transformer inductor circuit 400 to provide superior overall performance compared to conventional TLVR implementations. The dual-state behavior may eliminate the traditional trade-off between steady-state efficiency and transient response performance, enabling mobile device power delivery systems to achieve both objectives simultaneously through the integrated compensation functionality of the HMSI approach.

The transient response improvements shown in the graph 1000B enable the use of smaller output capacitors in mobile device power delivery systems, as the faster settling time may reduce the energy storage requirements needed to maintain stable output voltage during load transients. The reduced output capacitor requirements provide additional space savings and cost reductions in mobile device applications where component size and bill of materials optimization may be important design considerations.

A number of implementations have been described. Nevertheless, it will be understood that various modifications may be made without departing from the spirit and scope of the disclosure. Accordingly, other implementations are within the scope of the claims.

The techniques described in this disclosure may also be illustrated in the following examples.
Example 1. A transformer inductor, comprising: a primary power coil; a secondary coil positioned concentrically with respect to the primary power coil; a dielectric positioned between the primary power coil and the secondary coil to provide electrical isolation while enabling magnetic coupling therebetween; a molded magnetic material at least partially encasing the primary power coil and the secondary coil; and a hard saturation magnetic material disposed at the secondary coil and configured to provide a higher inductance at lower current levels and a reduced inductance at higher current levels, wherein the primary power coil and the secondary coil are configured to provide magnetic coupling enabling both inductive energy storage and transformer coupling.
Example 2. The transformer inductor of claim 1, wherein the primary power coil comprises a larger cross-sectional area than the secondary coil.
Example 3. The transformer inductor of any one or more of claims 1-2, wherein the primary power coil and the secondary coil comprise flat ribbon-like conductors that follow parallel paths in substantially a same plane.
Example 4. The transformer inductor of any one or more of claims 1-3, wherein the secondary coil is positioned concentrically with respect to the primary power coil to form a concentric arrangement.
Example 5. The transformer inductor of any one or more of claims 1-4, wherein the primary power coil forms an outer ring structure surrounding the secondary coil.
Example 6. The transformer inductor of any one or more of claims 1-5, wherein the primary power coil and the secondary coil are arranged in substantially parallel planes separated in a vertical direction.
Example 7. The transformer inductor of any one or more of claims 1-6, wherein the primary power coil and the secondary coil have overlapping areas that facilitate magnetic coupling through the vertical separation.
Example 8. The transformer inductor of any one or more of claims 1-7, wherein the primary power coil and the secondary coil each have a shape selected from a group consisting of circular, rectangular, and square.
Example 9. The transformer inductor of any one or more of claims 1-8, wherein the primary power coil and the secondary coil comprise a conductive material selected from the group consisting of copper, aluminum, silver, and gold.
Example 10. The transformer inductor of any one or more of claims 1-9, wherein the dielectric comprises a material selected from the group consisting of polyimide, urethane, epoxy glass, and oxide.
Example 11. The transformer inductor of any one or more of claims 1-10, further comprising: a composite magnetic core comprising a first magnetic material having hard saturation characteristics and the molded magnetic material having soft saturation characteristics; and an air gap positioned within the first magnetic material, wherein the primary power coil and the secondary coil are configured to provide variable magnetic coupling based on current levels flowing through the coils.
Example 12. A transformer inductor, comprising: a first conductive coil; a second conductive coil positioned concentrically with respect to the first conductive coil; a dielectric positioned between the first and second conductive coils; a composite magnetic core comprising a first magnetic material having hard saturation characteristics and a second magnetic material having soft saturation characteristics, wherein the composite magnetic core at least partially encases the first and second conductive coils; and an air gap positioned within the first magnetic material, wherein the first and second conductive coils are configured to provide variable magnetic coupling based on current levels flowing through the coils.
Example 13. The transformer inductor of claim 12, wherein the first magnetic material comprises ferrite material and the second magnetic material comprises powdered iron material.
Example 14. The transformer inductor of any one or more of claims 12-13, wherein the variable magnetic coupling provides higher inductance during low current operation and lower inductance during high current operation.
Example 15. The transformer inductor of any one or more of claims 12-14, wherein a transition from the higher inductance to lower inductance occurs when current exceeds a predetermined threshold determined by saturation characteristics of the first magnetic material.
Example 16. The transformer inductor of any one or more of claims 12-15, wherein the predetermined threshold is approximately 0.7 amperes.
Example 17. The transformer inductor of any one or more of claims 12-16, wherein the air gap is configured to control magnetic flux density within the first magnetic material to adjust saturation characteristics of the composite magnetic core.
Example 18. A transformer inductor for mobile device voltage regulation, comprising: an outer coil structure; an inner coil structure positioned concentrically within the outer coil structure; a micro-thin dielectric layer separating the outer coil structure from the inner coil structure; and a molded magnetic material encapsulating the outer coil structure, the inner coil structure, and the micro-thin dielectric layer to form a low-profile package having a height below 3 mm, wherein the inner coil structure is positioned concentrically with respect to the outer coil structure to form a concentric arrangement and provide a coupling coefficient approaching unity while maintaining electrical isolation through the micro-thin dielectric layer.
Example 19. The transformer inductor of claim 18, wherein the outer coil structure comprises a larger cross-sectional area than the inner coil structure.
Example 20. The transformer inductor of any one or more of claims 18-19, wherein the molded magnetic material comprises a material selected from the group consisting of ferrite, iron powder, Manganese-Zinc alloy, Nickel-Zinc alloy, or any suitable ferromagnetic material.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

What is claimed is:

1. A transformer inductor, comprising:
a primary power coil;
a secondary coil positioned concentrically with respect to the primary power coil;
a dielectric positioned between the primary power coil and the secondary coil to provide electrical isolation while enabling magnetic coupling therebetween;
a molded magnetic material at least partially encasing the primary power coil and the secondary coil; and
a hard saturation magnetic material disposed at the secondary coil and configured to provide a higher inductance at lower current levels and a reduced inductance at higher current levels,
wherein the primary power coil and the secondary coil are configured to provide magnetic coupling enabling both inductive energy storage and transformer coupling.

2. The transformer inductor of claim 1, wherein the primary power coil comprises a larger cross-sectional area than the secondary coil.

3. The transformer inductor of claim 1, wherein the primary power coil and the secondary coil comprise flat ribbon-like conductors that follow parallel paths in substantially a same plane.

4. The transformer inductor of claim 1, wherein the secondary coil is positioned concentrically with respect to the primary power coil to form a concentric arrangement.

5. The transformer inductor of claim 4, wherein the primary power coil forms an outer ring structure surrounding the secondary coil.

6. The transformer inductor of claim 1, wherein the primary power coil and the secondary coil are arranged in substantially parallel planes separated in a vertical direction.

7. The transformer inductor of claim 6, wherein the primary power coil and the secondary coil have overlapping areas that facilitate magnetic coupling through the vertical separation.

8. The transformer inductor of claim 1, wherein the primary power coil and the secondary coil each have a shape selected from the group consisting of circular, rectangular, and square.

9. The transformer inductor of claim 1, wherein the primary power coil and the secondary coil comprise a conductive material selected from the group consisting of copper, aluminum, silver, and gold.

10. The transformer inductor of claim 1, wherein the dielectric comprises a material selected from the group consisting of polyimide, urethane, epoxy glass, and oxide.

11. The transformer inductor of claim 1, further comprising
a composite magnetic core comprising a first magnetic material having hard saturation characteristics and the molded magnetic material having soft saturation characteristics; and
an air gap positioned within the first magnetic material,
wherein the primary power coil and the secondary coil are configured to provide variable magnetic coupling based on current levels flowing through the coils.

12. A transformer inductor, comprising:
a first conductive coil;
a second conductive coil positioned concentrically with respect to the first conductive coil;
a dielectric positioned between the first and second conductive coils;
a composite magnetic core comprising a first magnetic material having hard saturation characteristics and a second magnetic material having soft saturation characteristics, wherein the composite magnetic core at least partially encases the first and second conductive coils; and
an air gap positioned within the first magnetic material,
wherein the first and second conductive coils are configured to provide variable magnetic coupling based on current levels flowing through the coils.

13. The transformer inductor of claim 12, wherein the first magnetic material comprises ferrite material and the second magnetic material comprises powdered iron material.

14. The transformer inductor of claim 12, wherein the variable magnetic coupling provides higher inductance during low current operation and lower inductance during high current operation.

15. The transformer inductor of claim 14, wherein a transition from the higher inductance to lower inductance occurs when current exceeds a predetermined threshold determined by saturation characteristics of the first magnetic material.

16. The transformer inductor of claim 15, wherein the predetermined threshold is approximately 0.7 amperes.

17. The transformer inductor of claim 12, wherein the air gap is configured to control magnetic flux density within the first magnetic material to adjust saturation characteristics of the composite magnetic core.

18. A transformer inductor for mobile device voltage regulation, comprising:
an outer coil structure;
an inner coil structure positioned concentrically within the outer coil structure;
a micro-thin dielectric layer separating the outer coil structure from the inner coil structure; and
a molded magnetic material encapsulating the outer coil structure, the inner coil structure, and the micro-thin dielectric layer to form a low-profile package having a height below 3 mm,
wherein the inner coil structure is positioned concentrically with respect to the outer coil structure to form a concentric arrangement and provide a coupling coefficient approaching unity while maintaining electrical isolation through the micro-thin dielectric layer.

19. The transformer inductor of claim 18, wherein the outer coil structure comprises a larger cross-sectional area than the inner coil structure.

20. The transformer inductor of claim 18, wherein the molded magnetic material comprises a material selected from the group consisting of ferrite, iron powder, Manganese-Zinc alloy, Nickel-Zinc alloy, or any suitable ferromagnetic material.
